(19) United States
(12) Patent Application Publication
(10) Pub. No.: US 2015/0295784 A1
(43) Pub. Date: Oct. 15, 2015

(54) REMOTE MAINTENANCE SERVER, TOTAL MAINTENANCE SYSTEM INCLUDING THE REMOTE MAINTENANCE SERVER AND METHOD THEREOF

(71) Applicant: LG Electronics, Inc., Seoul (KR)

(72) Inventors: Myungkyoon Kim, Seoul (KR); Chisun Ahn, Seoul (KR); Juntae Kim, Seoul (KR)

(73) Assignee: LG Electronics, Inc., Seoul (KR)

(21) Appl. No.: 14/683,417

(22) Filed: Apr. 10, 2015

(30) Foreign Application Priority Data
Apr. 11, 2014 (KR) 10-2014-0043801

(51) Int. Cl. H04L 12/24; G06Q 10/00

(52) U.S. Cl. CPC H04L 41/22; G06Q 10/20; H04L 41/046

(57) ABSTRACT

The present disclosure discloses a remote maintenance server including a communication unit configured to transmit and receive data to and from a facility which is a control subject, a display unit configured to display a graphic object corresponding to the facility installed in a control site on a design drawing for the control site; and a controller configured to receive the status information of the facility corresponding to the graphic object through the communication unit and display it on the display unit.

### CROSS-REFERENCE TO RELATED APPLICATIONS

The present disclosure relates to subject matter contained in priority Korean Application No. 10-2014-0043801, filed on Apr. 11, 2014 which is herein expressly incorporated by reference in its entirety.

### BACKGROUND OF THE DISCLOSURE

1. Field of the Disclosure

The present disclosure relates to a remote maintenance server, a remote maintenance system including the same and a remote maintenance method thereof, and more particularly, to a remote maintenance server for displaying a design drawing for a control site and graphic objects corresponding to facilities, and the like.

2. Description of the Background Art

In recent years, the need for a remote maintenance system (remote total maintenance system (TMS)) for remotely maintaining a plurality of control regions (control sites, maintenance points) provided with a facility consuming energy has been recognized.

Here, the plurality of control regions may be structures or buildings disposed at various locations.

In case of conventional structure or buildings, as facilities provided therein are modernized, automatic control systems for automatically controlling sub-systems (facilities or apparatuses) such as power, lighting, conditioning, fire, security, and the like are expanded.

In line with that, the development of central monitoring systems such as a building management system (BMS) capable of managing sub-systems in a totally integrated manner have been actively carried out.

However, the role of such a building management system is concentrated on controlling the functions of facilities provided in one building.

Accordingly, a management system for maintaining, repairing facilities provided in each building and managing an amount of energy (or power) consumption thereof is needed, and in particular, a remote total maintenance system for remotely managing a plurality of controls sites in an integrated manner has been required.

### SUMMARY OF THE DISCLOSURE

A technical task aspect of the present disclosure is to provide a remote maintenance server for displaying graphic objects for facilities installed in a control site on a design drawing for the control site to provide them to an administrator, a remote maintenance system including the same, and a remote maintenance method using the same.

As a means for solving the foregoing technical task, the present disclosure discloses a remote maintenance server including a communication unit configured to transmit and receive data to and from a facility which is a control subject, a display unit configured to display a graphic object corresponding to the facility installed in a control site on a design drawing for the control site, and a controller configured to receive the status information of the facility corresponding to the graphic object through the communication unit and display it on the display unit.

According to an embodiment, the remote maintenance server may further include a reader unit configured to read a program instruction comprising information on the design drawing and the facility, wherein the controller extracts information on the design drawing and the facility from the program instruction.

According to an embodiment, the controller may convert information extracted from the program instruction to be displayed through a web browser.

According to an embodiment, the controller may transmit a control command to the facility corresponding to the graphic object according to a user input to the graphic object or a preset schedule.

According to an embodiment, the communication unit may receive status information from the facility, and the display unit may display the graphic object according to the status information of a facility corresponding to the graphic object.

According to an embodiment, when a facility corresponding to the graphic object is an abnormal facility, the display unit may display a graphic object corresponding to the abnormal facility in a different attribute from that of a graphic object corresponding to the same type of facility.

According to an embodiment, the display unit may display the graphic object corresponding to an abnormal facility in a different color or different size from that of a graphic object corresponding to the same type of facility, or display the color or size of the graphic object to be changed with time, or display the graphic object to blink.

According to an embodiment, the program instruction may include information on a control zone corresponding to the facility among the control sites, and the controller may read information on the control zone using the reader unit, and the display unit may display the control zone on the design drawing.

According to an embodiment, the controller may calculate a thermal load on the control zone, and the display unit may display the thermal load.

According to an embodiment, the display unit may display a graphic object corresponding to a pipe connected between the facilities.

According to an embodiment, the display unit may display a schematic diagram showing a connection relation between a plurality of the facilities excluding a design drawing for the control site.

According to an embodiment, the remote maintenance server may further include an input unit configured to receive an editing input to the graphic object.

Furthermore, there is provided a remote maintenance system including a remote maintenance server for remotely controlling facilities and a terminal connected to the remote maintenance server in a communicable manner, wherein the remote maintenance server includes a reader unit configured to read a program instruction comprising information on a design drawing for a control site and the facility, a controller configured to extract information on the design drawing and the facility from the program instruction, and a communication unit configured to transmit the extracted information to the terminal to allow the terminal to display the design drawing and a graphic object corresponding to the facility.

According to an embodiment, the terminal may receive and display the status information of a facility corresponding to the graphic object through the remote maintenance server.

According to an embodiment, the terminal may transmit a control command to control the facility corresponding to the graphic object through the remote maintenance server according to a user input or preset schedule.

According to an embodiment, the controller may convert the extracted information to be displayed through a web browser, and the communication unit may transmit the converted information to the terminal.

According to an embodiment, the terminal may transmit a program instruction containing information on the design drawing and the facility to the remote maintenance server.

Furthermore, the present disclosure discloses a remote maintenance method using a remote maintenance server for remotely controlling a facility, and the method may include allowing the remote maintenance server to display a design drawing for a control site and a graphic object corresponding to the facility installed in the control site, and allowing the remote maintenance server to receive and display the status information of a facility corresponding to the graphic object.

According to an embodiment, the method may further include allowing the remote maintenance server to read a program instruction comprising information on a design drawing for the control site and the facility, and allowing the remote maintenance server to extract information on the design drawing and the facility from the program instruction.

According to an embodiment, the method may further include allowing the remote maintenance server to convert information extracted from the program instruction to be displayed through a web browser.

According to an embodiment, the method may further include allowing the remote maintenance server to transmit a control command to the facility corresponding to the graphic object according to a user input to the graphic object or a preset schedule.

According to an embodiment, the method may further include allowing the remote maintenance server to determine an abnormal facility among the facilities, wherein said displaying the graphic object allows the remote maintenance server to display a graphic object corresponding to the abnormal facility in a different attribute from that of a graphic object corresponding to the same type of facility when a facility corresponding to the graphic object is an abnormal facility.

According to an embodiment, said displaying the graphic object displays the graphic object corresponding to an abnormal facility in a different color or different size from that of a graphic object corresponding to the same type of facility, or displays the color or size of the graphic object to be changed with time, or displays the graphic object to blink.

According to an embodiment, the program instruction may include information on a control zone corresponding to the facility among the control sites, wherein said displaying the graphic object displays the control zone on the design drawing.

According to an embodiment, said displaying the graphic object may display a graphic object corresponding to a pipe connected between the facilities.

According to an embodiment, said displaying the graphic object may display a schematic diagram showing a connection relation between a plurality of the facilities excluding a design drawing for the control site.

According to an embodiment, the remote maintenance server may further include receiving an editing input to the graphic object.

Furthermore, the present disclosure discloses a remote maintenance method using a remote maintenance server for remotely controlling facilities, and the method may include allowing the remote maintenance server to read a program instruction comprising information on a design drawing for the control site and the facility, allowing the remote maintenance server to extract information on the design drawing and the information on the facility from the program instruction, allowing the remote maintenance server to transmit the extracted information to a terminal connected to the remote server in a communicable manner, and allowing the terminal to display the design drawing and a graphic object corresponding to the facility.

According to an embodiment, the method may further include allowing the terminal to receive and display the status information of a facility corresponding to the graphic object through the remote maintenance server.

Furthermore, the present disclosure discloses a computer-readable recording medium on which a computer program for executing the remote maintenance method is written.

A remote maintenance server according to an embodiment disclosed in the present disclosure, a remote maintenance system including the same and a remote maintenance method thereof may display a design drawing for a control site, and display a graphic object corresponding to a facility at a specific position on the design drawing, thereby allowing an administrator to accurately recognize a position at which the facility is installed at the control site.

Furthermore, when an abnormal facility occurs among a plurality of facilities while the administrator monitors the whole design drawing, the administrator may quickly recognize that the abnormal facility has occurred among the plurality of facilities as well as at which position the failed facility is disposed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1A is a conceptual view in the aspect of relationship between constituent elements illustrating a remote total maintenance system according to an embodiment disclosed in the present disclosure;

FIG. 1B is a conceptual view in the aspect of geographical location relationship between constituent elements illustrating a remote total maintenance system according to an embodiment disclosed in the present disclosure;

FIG. 2 is a configuration diagram illustrating the configuration of a remote maintenance system according to an embodiment disclosed in the present disclosure;

FIG. 3 is an exemplary view illustrating a specific connection relationship between a local controller and facilities or apparatuses in a remote total maintenance system (or remote maintenance system) according to an embodiment disclosed in the present disclosure;

FIG. 4 is an exemplary view specifically illustrating a connection structure between a remote maintenance server and a plurality of local controllers in a remote total maintenance system (or remote maintenance system) according to an embodiment disclosed in the present disclosure;

FIG. 5 is a configuration diagram briefly illustrating the configuration of a remote maintenance server according to an embodiment disclosed in the present disclosure;

FIG. 6 is an exemplary view illustrating a graphic object corresponding to a facility provided to an administrator in a list format according to an embodiment disclosed in the present disclosure;

FIG. 7 is a view illustrating a screen displayed with a design drawing for a control site and a graphic object corresponding to a facility according to an embodiment disclosed in the present disclosure;

FIG. 8 is an exemplary view illustrating a screen for maintaining a design drawing for a control site information on a facility in a remote maintenance server according to an embodiment disclosed in the present disclosure;

FIG. 9 is an exemplary view illustrating a design drawing for a control site according to an embodiment disclosed in the present disclosure;

FIG. 10 is an exemplary view illustrating a schematic diagram for a plurality of facilities according to an embodiment disclosed in the present disclosure;

FIG. 11 is an exemplary view illustrating an external terminal connected to a remote maintenance server according to an embodiment of the present disclosure;

FIG. 12 is a configuration diagram illustrating the configuration of a terminal connected to a remote maintenance server according to an embodiment disclosed in the present disclosure; and

FIG. 13 is a step-by-step flow chart illustrating a remote maintenance method using a remote maintenance server according to an embodiment of the present disclosure.

### DETAILED DESCRIPTION OF THE INVENTION

In the following, preferred embodiments of the present invention will be described in detail with reference to the accompanying drawings to such an extent that the present invention can be easily embodied by a person having ordinary skill in the art to which the present invention pertains. However, the present invention may be implemented in various different forms, and therefore, the present invention is not limited to the illustrated embodiments. In order to clearly describe the present invention, parts not related to the description are omitted, and like reference numerals designate like constituent elements throughout the specification.

Hereinafter, detailed technical content to be implemented by the present disclosure will be specifically and clearly described with reference to the accompanying drawings.

Remote Total Maintenance System

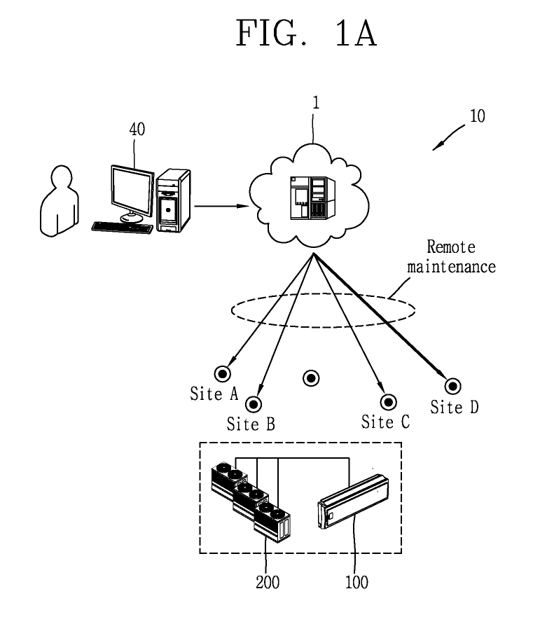

Hereinafter, a remote total maintenance system (or remote maintenance system) according to an embodiment disclosed in the present disclosure will be described in detail with reference to FIGS. 1A through 4.

However, a remote total maintenance system disclosed in FIGS. 1A through 4 is only illustrative, and it should be understood by those skilled in the art that technologies disclosed in the present disclosure can be applicable to various types of remote maintenance systems, point maintenance systems, store maintenance systems or chain store maintenance systems.

FIGS. 1A and 1B are conceptual views illustrating a remote total maintenance system according to an embodiment disclosed in the present disclosure.

FIG. 1A is a conceptual view in the aspect of relationship between constituent elements illustrating a remote total maintenance system according to an embodiment disclosed in the present disclosure.

Referring to FIG. 1A, a remote total maintenance system 10 according to an embodiment of the present disclosure may include at least one facility 200 consuming energy, a local controller 100 configured to control or maintain the at least one facility 200, and a remote maintenance server 1.

The remote maintenance server 1 may perform the role of maintaining, repairing and managing at least one control region, control side or maintenance point (site A˜site D).

Each of the at least one control region (site A˜site D) may include the at least one facility 200 consuming energy or power.

Furthermore, the at least one control region (site A˜site D) may include a local controller 100 for controlling or managing the at least one facility.

The remote maintenance server 1 may remotely monitor the status of at least one facility 200 provided in the at least one control region (site A˜site D), respectively, thereby performing a maintenance, repair and management function on the at least one facility 200.

Here, the status of the at least one facility 200 may be a status associated with at least one of a control setting state, an operation state and a fault state corresponding to the at least one facility 200.

Here, the control setting state may denote a control attribute or control parameter on the at least one facility 200 and denote a variable having various control objects under the control of the facility.

For example, when the facility is an air conditioner, the control setting, control attribute or control parameter may be a target temperature (or set temperature), an upper limit temperature, a lower limit temperature, a flow rate, whether it is running or stopped, and the like.

On the contrary, for example, when the facility is a lighting fixture, the control setting, control attribute or control parameter may be illumination, brightness, and the like.

The remote maintenance server 1 may detect a fault status or the like of the at least one facility 200. In this case, the remote maintenance server 1 may acquire status information on the at least one facility 200 from the local controller 100.

When a specific facility of the at least one facility 200 is failed, the remote maintenance server 1 may access a service center (specifically, service center server) (not shown) providing a service for repairing the facility to request a repair work so as to carry out repair on the specific facility. Upon receiving a request for the repair work, the service center may carry out a work for dispatching a service technician for repair work to a control site provided with the specific facility. The detailed description thereof will be described later.

Communication between the remote maintenance server 1 and the local controller 100 may be carried out in various communication modes or communication protocols.

For example, the remote maintenance server 1 and the local controller 100 may perform communication in at least one communication mode or communication protocol of a mobile communication network, Transmission Control Protocol/Internet Protocol (TCP/IP), Local Area Network (LAN), Wireless LAN, Wi-Fi, Wireless Broadband (Wibro) and World Interoperability for Microwave Access (Wimax).

Communication between the local controller 100 and the at least one facility 200 may be carried out in various communication modes or communication protocols.

For example, the local controller 100 and the at least one facility 200 may perform communication in a wired communication mode such as RS-232, RS-485, universal serial bus (USB), IEEE 1394, Thunderbolt, and the like.

Furthermore, the remote maintenance system 10 may further include an additional terminal 40 connected to the remote maintenance server 1 in a wired or wireless manner.

A user or administrator of the remote maintenance system 10 may access the remote maintenance server 1 through the additional terminal 40 to remotely maintain the at least one control region (site A˜site D).

The additional terminal 40 may denote a terminal in a broad sense to have a concept containing a portable terminal. For example, the additional terminal 40 may denote various devices or apparatuses, such as a personal computer, a digital television (TV), a smart TV, a smart phone, a portable terminal, a mobile terminal, a personal digital assistant (PDA), a portable multimedia player (PMP) terminal, a laptop computer, a Wibro terminal, an internet protocol television terminal (IPTV), a digital broadcast terminal, a telematics terminal, a navigation terminal, an audio video navigation terminal, a television, a 3D television, an audio/video (A/V) system, a home theater system, an information providing center, a call center, and the like.

FIG. 1B is a conceptual view in the aspect of geographical location relationship between constituent elements illustrating a remote total maintenance system according to an embodiment disclosed in the present disclosure.

Referring to FIG. 1B, the remote total maintenance system 10 according to an embodiment of the present disclosure may perform a function of remotely maintaining control regions, control sites or maintenance points (11-19) disposed at various locations across the country.

The remote maintenance system 10 may include at least one control region (11-19) provided with a facility (or facility device) consuming energy, and the remote maintenance server 1 configured to maintain the at least one control region (11-19).

The at least one control region (11-19) may correspond to site A through site D illustrated in FIG. 1A.

The remote maintenance system 10 may having a structure in which the at least one control region (11-19) are mutually connected across the country.

As illustrated in FIG. 1B, the remote maintenance system 10 may form one network in which the at least one control region (11-19) provided with a facility device are distributed over a broad region, and connected to the remote maintenance server 1.

Here, the remote maintenance system 10 may further include a regional server (not shown) connected to at least one specific control region of the at least one control region (11-19) to maintain the specific control region, and connected to the remote maintenance server 1.

The regional server may be an additional server for relaying data between the specific control region and the remote maintenance server 1 or any one of the plurality of control regions may be operated as a server.

Here, each of the control regions (11-19) may be distributed across the country or in some areas.

Furthermore, each of the control regions (11-19) may be connected to the remote maintenance server 1, and the remote maintenance server 1 may monitor a plurality of control regions to maintain the operation.

For example, each control region may denote a maintenance object that should be collectively maintained by the center (or headquarter) or a maintenance point that should be maintained, repaired and managed by a remote maintenance server, and may have a broad concept including a structure, a building, a store, a mall and a school, and the like.

For example, when the control region is a store, the control region may be a chain store such as a convenience store, a bakery, and the like.

The remote maintenance system 10 may form at least one control region (11-19) provided with an air conditioner as well as other facility devices as a network as illustrated in FIG. 1B, thereby allowing the remote maintenance server 1 to maintain and control a plurality of control regions distributed thereover.

Here, the remote maintenance system 10 may maintain consumption power (or energy consumption) for each point in a national level as well as in a regional level, and moreover, broadly maintain it over a wide range including a plurality of countries.

Each of the at least one control region (11-19) may include one or more facilities (or facility devices) and apparatuses.

As a facility (or sub-system) provided within the control region, the facility may denote an air conditioner, a ventilator, an air conditioning unit (air handling unit), a fan, a boiler, a cooling tower, a pump, a temperature/humidity sensor, a chiller unit, a lighting fixture, a power device, a refrigerator, a freezer, a showcase, a fire system, and the like.

Furthermore, when a cooling tower system is used as a facility, for example, the apparatus may denote a cooling tower, a pump, a temperature sensor, and the like.

According to an embodiment disclosed in the present disclosure, the remote maintenance server 1 may acquire information on an amount of energy consumption during a specific time period in the at least one control region (11-19).

Here, the specific time period may be specified or set by the user.

Furthermore, the specific time period may be specified in the unit of days, weeks or months.

For example, the remote maintenance server 1 may acquire information on the amount of energy consumption per each day. Furthermore, for example, the remote maintenance server 1 may acquire information on an amount of energy consumption from January 1 to January 20.

According to an embodiment, the remote maintenance server 1 may divide the at least one control region (11-19) into at least one group (control group, maintenance group, family, control family or maintenance family) based on a specific classification criterion.

There may be a plurality of specific classification criteria. Accordingly, when there is a plurality of specific classification criteria, classification into the at least one group may be carried out on the basis of the foregoing multidimensional clustering techniques.

The classification criterion may be a classification criterion according to regional characteristics (characteristics for a control site or maintenance point) for the at least one control region (11-19).

According to an embodiment, the regional characteristics may include at least one of a static attribute and a dynamic attribute of the control region.

The static attribute may be at least one of a size of the at least one control region (11-19), a location of the at least one control region (11-19), and a facility capacity for a facility installed (or provided) in the at least one control region (11-19).

For example, an attribute for the size of the at least one control region (11-19) may denote an area, a floor height, a number of floors, and a window width, and the like of the region.

Furthermore, for example, an attribute for the location of the at least one control region (11-19) may denote a direction (east, west, south, north), a latitude, a longitude and geographical location, and the like, at which the at least one control region (11-19) is located.

Furthermore, for example, the facility capacity for a facility may denote a number of lighting fixtures, a power consumption of lighting fixture, a number of air conditioners, a capacity of air conditioner, a number of refrigeration facilities, a capacity of refrigeration facility, and the like.

Furthermore, the dynamic attribute may be weather information corresponding to a point (or region) at which the at least one control region (11-19) is located.

For example, the dynamic attribute may include at least one of daily average ambient temperature, maximum ambient temperature and minimum ambient temperature, rainfall, snowfall and cloudiness corresponding to a point (or region) at which the at least one control region (11-19) is located.

Specifically, the remote maintenance server 1 may divide the at least one control region (11-19) into a plurality of groups based on a store size (area) and a scale of lighting (number of lighting fixtures).

For example, the remote maintenance server 1 may divide the at least one control region (11-19) into a large-scale group (first group) with a large size of the control region and a large scale of the lighting, a medium-scale group (second group) with a medium size of the control region and a medium scale of the lighting, and a small-scale group (third group) with a small size of the control region and a small scale of the lighting.

In this case, each of the first to the third group may include at least one control region corresponding to this.

According to an embodiment, there may be a plurality of the classification criteria.

For example, the classification criteria may include a plurality of classification criteria for the foregoing static attribute and dynamic attribute of a control region.

In this case, the remote maintenance server 1 may apply a multidimensional clustering technique to classify the at least one control region (11-19) into the at least one group according to the plurality of classification criteria.

The multidimensional clustering technique may be carried out in various ways.

For example, the multidimensional clustering technique may be a K-means clustering technique.

The K-means clustering technique may denote a classification or clustering method of selecting a number (k) of individual clusters and criterion thereof from a plurality of data sets, and allowing the means close to the relevant criterion to belong to the relevant cluster.

In addition, it should be clearly understood by those skilled in the art that various clustering techniques can be applicable to a technology disclosed in the present disclosure.

According to an embodiment, classification into the at least one group may be carried out in various requests.

For example, the remote maintenance server 1 may periodically perform the classification work according to a user request (or user input).

Furthermore, for example, the remote maintenance server 1 may perform the classification work according to the need, and specifically for example, the remote maintenance server 1 may automatically perform the classification work when a new control region, control site or maintenance point is added.

Furthermore, for example, the remote maintenance server 1 may periodically perform the classification. Specifically, for example, the remote maintenance server 1 may perform the classification in the unit of days, weeks or months.

Considering a specific scenario of the execution of group classification according to an embodiment disclosed in the present disclosure, the remote maintenance server 1 may classify control regions into groups according to a static attribute of the foregoing classification criteria.

It is because the static attribute is not a frequently modified or changed classification criterion in terms of time, and classification is carried out only when registering a new control region.

Furthermore, the remote maintenance server 1 may reclassify the control regions in the unit of days on the basis of a classification result based on the dynamic attribute according to a dynamic attribute of the foregoing classification criteria.

It is because the dynamic attribute has a characteristic of being changed in the unit of days and periodic classification is required.

Finally, the remote maintenance server 1 may generate a control command in the unit of groups based on a final group sequentially classified based on the static attribute and the dynamic attribute to control energy or power consumption in the unit of groups.

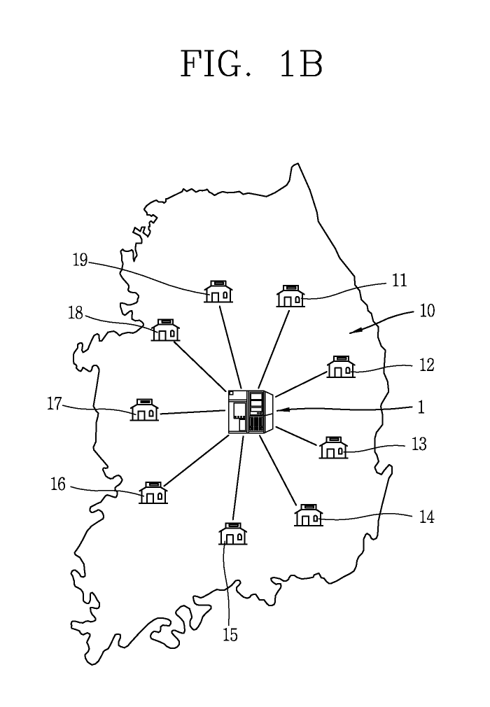

FIG. 2 is a configuration diagram illustrating the configuration of a remote maintenance system according to an embodiment of the present disclosure.

Referring to FIG. 2, the remote maintenance system (or remote total maintenance system) 10 according to an embodiment of the present disclosure may include a remote maintenance server 1, a local controller 100′, 100″ connected to the remote maintenance server 1 via a communication network, at least one facility 200′, 200″ and apparatus 300′, 300″.

As a sub-system constituting the remote maintenance system 10, the facility 200′, 200″ may denote an air conditioner, a ventilator, an air conditioning unit, a fan, a boiler, a cooling tower, a pump, a temperature/humidity sensor, a freezer, a lighting fixture, a power device, a fire system, and the like.

Furthermore, when a cooling tower system is used as a facility, for example, the apparatus 300′, 300″ may denote a cooling tower, a pump, a temperature sensor, and the like.

As a device for comprehensively controlling, monitoring or maintaining the entire situation of a building, the remote maintenance server 1 may include the facilities 200′, 200″, for example, additional terminals for machine equipment, lighting, power, access control, disaster prevention, parking management, facilities management, and the like.

The remote maintenance server 1 may be an automatic server for sharing information with the local controller 100′, 100″ through network communication, and controlling, monitoring or maintaining the facility 200′, 200″ and apparatus 300′, 300″ contained therein.

Here, the first local controller 100′ and the second local controller 100″ may denote local controllers provided at different control regions, control sites or maintenance points, respectively.

According to an embodiment disclosed in the present disclosure, the remote maintenance server 1 may collect information on facilities provided or disposed in the control regions, respectively, to efficiently maintain, repair or manage each of the control regions, respectively.

For the purpose of this, the remote maintenance server 1 may provide a user interface or input/output screen capable of receiving a user input and displaying the maintenance or repair process for a facility according to the user input and processing result thereof.

The control region, control site or maintenance point may denote a maintenance object that should be collectively maintained by the center (or headquarter) or a maintenance point that should be maintained, repaired and managed by a remote maintenance server, and may have a broad concept including a structure, a building, a store, a mall and a school, and the like.

Here, the structure or building may denote an architectural structure, and may denote a mall, a convenience store, a store, a home, an office, an officetel, a factory building, a school, a hospital building, or the like.

The local controller 100′, 100″ may be connected to the remote maintenance server 1 via a communication network to execute a management program received from the remote maintenance server 1.

The local controller 100′, 100″ may be referred to as an advanced control platform (ACP) due to the role of maintaining, repairing, controlling and managing the facilities 200′, 200″ within the control region.

Furthermore, the local controller 100′, 100″ may communicate and exchange information with the remote maintenance server 1, and receive and execute the management program or a control command according to the management program to control the facilities 200′, 200″.

Furthermore, the local controller 100′, 100″ may write or store facility-related information such as control output and status change of facilities within a control region through one or more apparatuses 400, 400′ provided in the facilities 200′, 200″, for example, sensors and manipulation devices, respectively.

The local controller 100′, 100″ may be a microcomputer configured to control, maintain or monitor the facility 200′, 200″ or apparatus 300′, 300″ according to the management program, for example.

In other words, the local controller 100′, 100″ may be connected to the remote maintenance server 1 via a communication network (P10) to transmit and receive required information with each other.

Accordingly, the local controller 100′, 100″ may directly control an input/output signal of the facility 200′, 200″ or apparatus 300′, 300″ to monitor, maintain or control air conditioning and other facilities provided in the control region.

Specifically, the local controller 100′, 100″ may be connected between the remote maintenance server 1 and the one or more facilities 200′, 200″ to receive a management program or a control command according to the management program to execute it.

Furthermore, the local controller 100′, 100″ may transmit the execution result to the remote maintenance server 1. To this end, the remote maintenance server 1 may include a communication unit as a device for transmitting the management program or a control command according to the management program and receiving an execution result according to the management program or a control command according to the management program from the local controller 100′, 100″.

The local controller 100′, 100″ may further include a display unit as a device for displaying the execution result on a user screen.

The remote maintenance server 1 and the local controller 100′, 100″ may be connected to each other via a communication network (P10).

According to an embodiment disclosed in the present disclosure, the communication network may include various communication protocols.

For example, the remote maintenance server 1 and the local controller 100′, 100″ may be at least one of a mobile communication network, Transmission Control Protocol/Internet Protocol (TCP/IP), Local Area Network (LAN), Wireless LAN, Wi-Fi, Wireless Broadband (Wibro) and World Interoperability for Microwave Access (Wimax).

Furthermore, according to an embodiment, the local controller 100′, 100″ may be connected to the facilities 200′, 200″ trough a communication network (P20′, P20″).

For example, the local controller 100′, 100″ may be connected to the facilities 200′, 200″ based on RS-485.

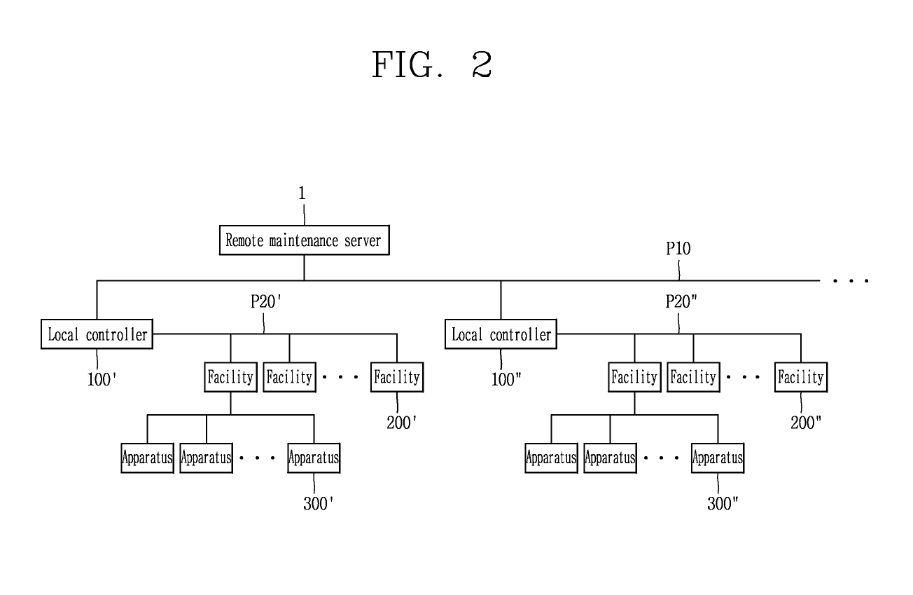

FIG. 3 is an exemplary view illustrating a specific connection relationship between a local controller and facilities or apparatuses in a remote total maintenance system (remote maintenance system) according to an embodiment disclosed in the present disclosure.

Referring to FIG. 3, the remote maintenance server 1 may be connected to the local controller 100 as described above.

Furthermore, the remote maintenance server 1 may include a terminal 40 that accesses the remote maintenance server 1 from the outside.

Furthermore, a heating and cooling device, such as an air conditioner, a cooler, a heating cabinet or the like, a lighting fixture and a security device may be provided within one maintenance point or control region 30′.

Furthermore, a plurality of power meters 151 to 154 connected to the facility devices, respectively, to measure an amount of power consumption.

Here, indoor units 154-1, 151-1, 151-2, an outdoor unit 154-2, a refrigerator 152-3, a show case 152-2, a heating cabinet 152-1, a calculator 153-1, a lighting fixture 151-3 may be provided in the store.

A plurality of indoor units 154-1, 151-1, 151-2 may perform air conditioning in a room, and the plurality of indoor units may be operated in a single or combined manner according to their indoor air-conditioning loads.

Furthermore, an air conditioner may further include a unit such as a ventilator, an air purifier, a dehumidifier, a humidifier and the like in addition to the indoor units and outdoor units, but an example in which indoor units and output units are installed therein will be described below, and the number of indoor units and output units may not be necessarily limited to the drawing.

Here, the indoor unit may include an indoor heat exchanger (not shown), an indoor fan (not shown), an expansion valve (not shown) configured to expand refrigerant supplied, and a plurality of sensors (not shown).

Furthermore, the output unit may include a compressor (not shown) configured to receive and compress refrigerant, a heat exchanger (not shown) configured to exchange heat between refrigerant and outdoor air, an accumulator (not shown) configured to extract gaseous refrigerant from the supplied refrigerant and supply it to the compressor, and a 4-way valve (not shown) configured to select a passage of refrigerant according to a heating operation.

At least one lighting fixture 151-3 may be installed, and controlled by a switch connected thereto.

The refrigerator 152-3 or show case 152-2 may maintain the inside at a preset temperature to store foods.

The show case 152-2 may expose cool air according to its cooling cycle to decrease its internal temperature.

The heating cabinet 152-1 may maintain its internal temperature above a predetermined temperature, thereby maintaining things therewithin to be warm.

Furthermore, the calculator 153-1 may manage cash and issue a receipt.

For facility devices provided at a point in such a manner, data and information on power consumption for each device in an operation state for each device may be maintained through the local controller 100 (or point controller) within the maintenance point or control region.

As a device for comprehensively controlling, maintaining or monitoring the entire situation of a control region, the local controller 100 may include facility devices provided or installed in the control region, for example, additional terminals for machine equipment, lighting, power, access control, disaster prevention, parking management, facilities management, and the like.

The local controller 100 may store energy data measured and entered from power meters 151 to 154, and store control data on each device and data on the operation state.

Furthermore, the local controller 100 may be connected to the remote maintenance server 1 to transmit and receive data, and change control settings for each device, and monitor its operation according to data received from the remote maintenance server 1.

Here, a unique account may be allocated to the remote maintenance server 1 for each point (or store) to issue an ID according to the account.

The local controller 100 may access the remote maintenance server 1 through an ID which is an account of the point, thereby receiving control data for the relevant point and control records.

Here, the control data may have a broad concept including the foregoing facility control schedule or facility maintenance schedule.

The facility control schedule may include information on a setting value according to the time of a control attribute or control parameter for the foregoing facilities.

Furthermore, as a schedule for maintaining or repairing the facilities, the facility maintenance schedule may include information on a maintenance and inspection schedule, past history, and the like of the facilities.

Furthermore, as a schedule for maintaining an amount of power consumption of the facilities, the facility maintenance schedule may include information on a setting value according to the time of a control attribute or control parameter for maintaining the amount of power consumption of the facilities under a predetermined value.

The local controller 100 may transmit information on an amount of power consumption (or energy consumption) for each control region collected and stored therein to the remote maintenance server 1, and receive its resultant rate information.

Furthermore, the local controller 100 may transmit its own facility control schedule or facility maintenance schedule to the remote maintenance server 1 according to the need or according to a request of the remote maintenance server 1.

The remote maintenance server 1 may divide each control region using an account allocated to each control region and transmit the requested data.

Furthermore, the local controller in each control region may access the remote maintenance server 1 using an account allocated to itself, and request data on each control region to the remote maintenance server 1.

Here, IDs with different authorities may be allocated to the remote maintenance server 1 and each control region, respectively, and data displayed according to the authority set to an ID during an access using the ID may be displayed in a limited manner.

During an access to the remote maintenance server 1 through an ID of the control region, control site or maintenance point, only data on the relevant maintenance point may be provided from the remote maintenance server 1.

The remote maintenance server 1 may control (or maintain) a plurality of control regions, control sites or maintenance points in an integrated manner or control (or maintain) in an individual manner according to the setting, and a predetermined maintenance point may be exceptionally processed during an integrated control (or maintenance).

Furthermore, the remote maintenance server 1 may provide data for a predetermined maintenance point according to an access account in connection with an access of the terminal 40 such as a portable terminal, a laptop computer, and the like.

Here, the data of a maintenance point corresponding to the access account may be transmitted regardless of the type of the accessed terminal.

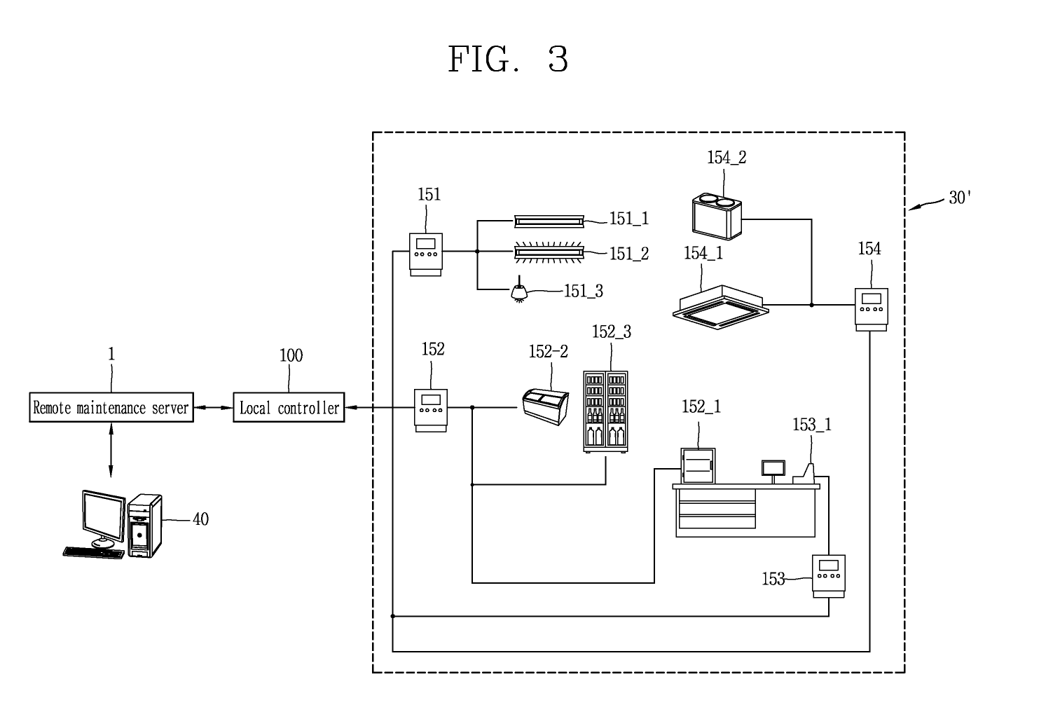

FIG. 4 is an exemplary view specifically illustrating a connection structure between a remote maintenance server and a plurality of local controllers in a remote total maintenance system (or remote maintenance system) according to an embodiment disclosed in the present disclosure.

Referring to FIG. 4, a remote total maintenance system according to an embodiment disclosed in the present disclosure may include a plurality of control regions, control sites or maintenance points 30 and a remote maintenance server 1 connected to the plurality of control regions 30 via a network.

Furthermore, the plurality of control regions 30, respectively, may include local controllers 100-1 to 100-3.

The local controllers 100-1 to 100-3 may perform the role of a gateway for converting various information or communication data according to a remote communication protocol to transmit or receive the converted information or data to or from the remote maintenance server 1. In other words, the local controllers 100-1 to 100-3 may perform the function of a router for transmitting and receiving signals corresponding to the various information or communication data.

In this case, the local controllers 100-1 to 100-3 may include a protocol conversion unit (not shown) configured to convert the various information or communication data according to a remote communication protocol.

According to a modified embodiment, a remote total maintenance system according to an embodiment disclosed in the present disclosure may include a gateway (not shown) configured to perform the role of a router.

In this case, the gateway may be disposed between to remote maintenance server 1 and the local controllers 100-1 to 100-3.

The remote maintenance server 1 may include a display unit (not shown) configured to display a device maintenance screen.

Here, the device maintenance screen may be a screen for displaying any one of air conditioning information, refrigeration information, power usage information, facility information, fault history information, fault setting information, and energy usage information.

The remote maintenance system may be connected to the remote maintenance server 1 via a network, and may further include a terminal 40 configured to receive and display the device maintenance data from the remote maintenance server 1.

The plurality of control regions 30 may include at least one facility or device 110-1 to 110-3 provided within the plurality of control regions 30.

Here, the facility or device 110-1 to 110-3 may include an air conditioner, a refrigerator, a freezer, a showcase, and the like, disposed within the plurality of control regions 30, and the remote maintenance server 1 may collect status data on the at least one facility or device 110-1 to 110-3.

The status data may include information on an indoor temperature when the each facility or device 110-1 to 110-3 is an air conditioner, and on an inside temperature when the each facility or device 110-1 to 110-3 is a refrigerator, a freezer or a showcase.

Furthermore, the status data may include humidity, a flow rate as well as a current temperature.

In addition, the facility or device 110-1 to 110-3 may include a facility within the control region such as a power meter or the like, and thus the status data may include information on an amount of power consumption of the each facility or device 110-1 to 110-3 and a total amount of power consumption (or energy consumption) thereof.

The plurality of control regions 30 may include a local controller 100-1 to 100-3 configured to receive the status data from the facility or device 110-1 to 110-3.

Furthermore, the local controller 100-1 to 100-3 may be also able to transmit data for remotely controlling or maintaining the facility or device 110-1 to 110-3 from the remote maintenance server 1 to the facility or device 110-1 to 110-3.

The remote maintenance server 1 may be connected to the facility or device 110-1 to 110-3 to generate fault history data when the status data continues to be greater than a preset threshold value.

Furthermore, the remote maintenance server 1 may display the fault history data for the user or administrator through a display device when the duration of the abnormal state passes a threshold time period.

Accordingly, the remote maintenance server 1 may notify the occurrence of abnormal state of a facility or device within the control region to the user or administrator, thereby allowing the user or administrator to effectively maintain a plurality of control regions.

Furthermore, the remote maintenance server 1 may also transmit the fault history data to an administrator server or a service center providing services associated with their maintenance or repair.

Remote Maintenance Server Displaying Design Drawing

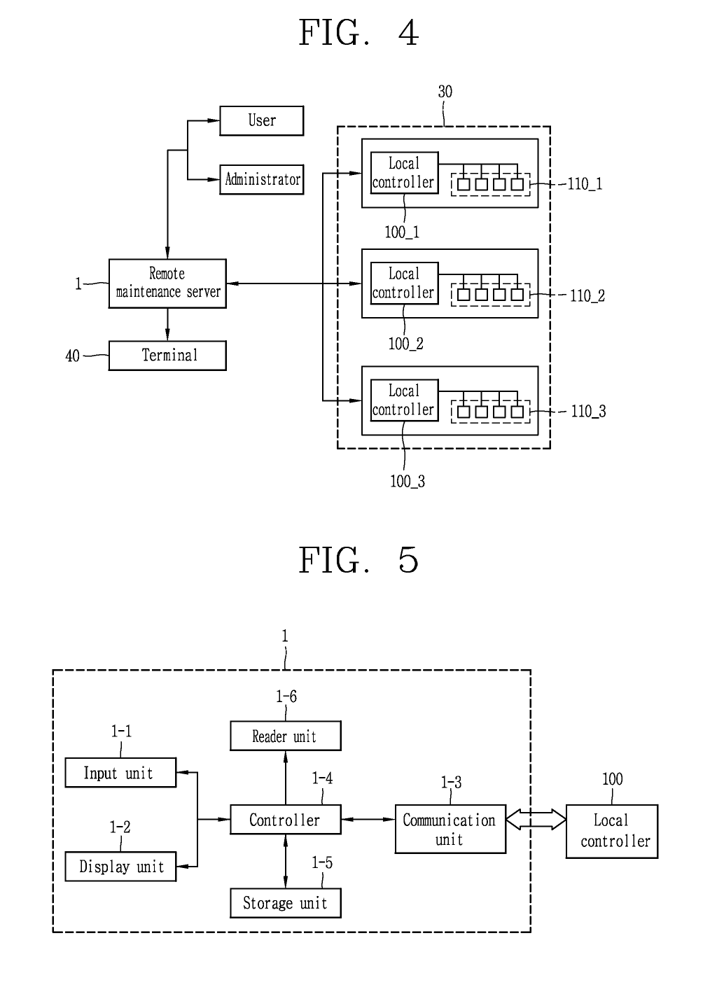

FIG. 5 is a configuration diagram briefly illustrating the configuration of a remote maintenance server according to an embodiment disclosed in the present disclosure.

As a server for remotely controlling various facilities 200, the remote maintenance server 1 according to an embodiment disclosed in the present disclosure may receive various control commands from a user through a terminal 40 connected to the remote maintenance server 1 or display the status of various facilities 200 as described above.

Accordingly, the user or administrator may remotely maintain at least one control site (site A˜site D) provided with the facilities 200.

Here, the remote maintenance server 1 may be connected to various facilities 200 provided at a site in a communicable manner, but as described above, a gateway 100 may be connected between the remote maintenance server 1 and the facilities 200 to convert a communication protocol, thereby allowing communication between the facilities 200 and the remote maintenance server 1 around the gateway 100.

As described above, the gateway 100 may be a local controller, and in this case, the gateway 100 may generate a control command to transmit it to the facilities 200 or transmit a control command received from the remote maintenance server 1 to the facilities 200.

On the other hand, as illustrated in FIG. 5, the remote maintenance server 1 according to an embodiment disclosed in the present disclosure may include an input unit 1-1, a display unit 1-2, a communication unit 1-3, a controller 1-4 and a storage unit 1-5.

The remote maintenance server 1 may be connected to an input unit 1-1 and a display unit 1-2 as interface devices around a controller 1-4 for controlling the entire operation of the remote maintenance server 1, and may include a communication unit 1-3 for transmitting and receiving data to and from various external terminals or the like and a storage unit 1-5 for storing various data generated during the processing process of the controller 1-4.

As a device for receiving various inputs from the user, the input unit 1-1 may receive individual or group-specific control commands (operation, stop, cooling, ventilation, desired temperature (or set temperature), etc.) from the facilities 200 connected to the remote maintenance server 1, and as a device for displaying a result processed by the controller 1-4, the display unit 1-2 may display the status information (current temperature, humidity, operation mode, etc.) of the facility received from the facilities 200.

As a device for communicating with the facilities 200, the communication unit 1-3 may directly communicate with the facilities 200, but as described above, preferably communicate with the facilities 200 through the local controller 100. Accordingly, the remote maintenance server 1 may transmit a control command to the facilities 200 through the communication unit 1-3 or receive status information from the facilities 200.

Here, communication between the remote maintenance server 1 and the local controller 100 may follow at least one communication mode or communication protocol of mobile communication network, Transmission Control Protocol/Internet Protocol (TCP/IP), Local Area Network (LAN), Wireless LAN, Wi-Fi, Wireless Broadband (Wibro) and World Interoperability for Microwave Access (Wimax) as described above.

The display unit 1-2 displays (outputs) information processed in the remote maintenance server 1.

The display unit 551 may include at least one of a Liquid Crystal Display (LCD), a Thin Film Transistor-LCD (TFT-LCD), an Organic Light Emitting Diode (OLED) display, a flexible display, a three-dimensional (3D) display, and a transparent display (for an example, Transparent OLED (TOLED)).

According to an embodiment, the display unit 1-2 may display a graphic object corresponding to a facility which is a control subject.

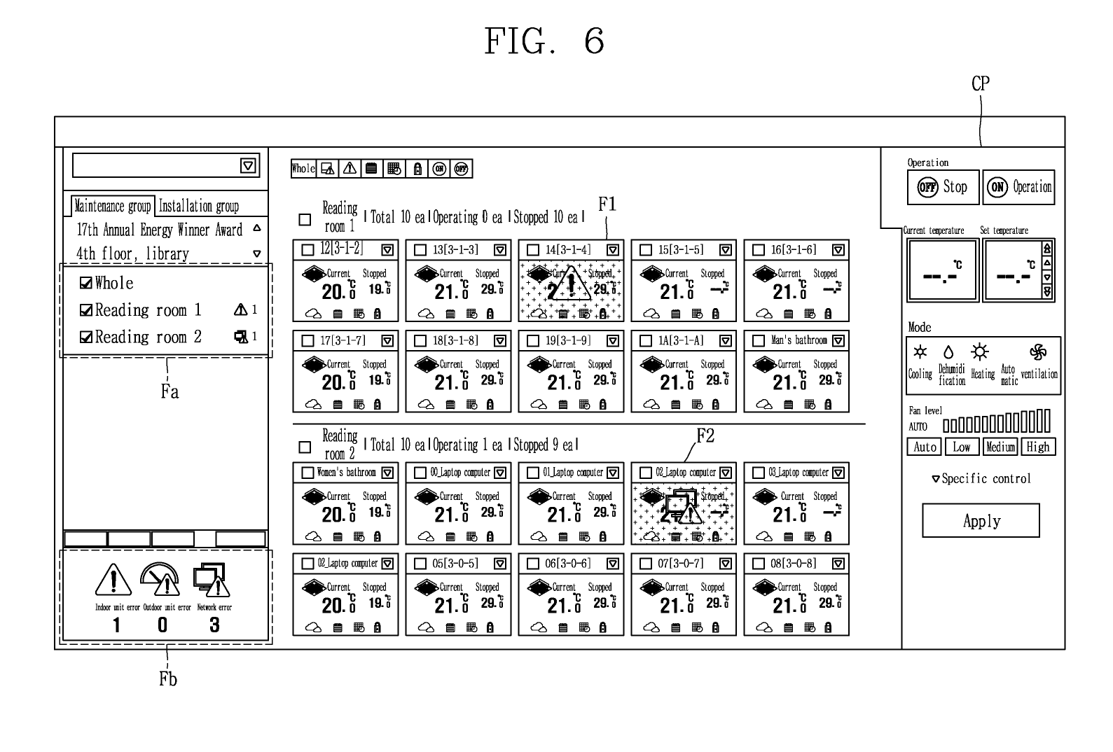

The display unit 1-2 may display graphic objects corresponding to a plurality of facilities in a list format as illustrated in FIG. 6.

The graphic objects for a plurality of facilities may be displayed in a list format, and preferably displayed in a divided manner for each group. For an example, graphic objects corresponding to 10 indoor units in a first reading room and 10 indoor units in a second reading room may be divided according to their location, and each graphic object divided according to the location may be preferably displayed in a separate region within the screen.

Here, the graphic object may be displayed in an icon format to allow the administrator to recognize a facility corresponding to this, and preferably displayed with any one or a combination of status information (operation or non-operation, operation mode, current temperature, target temperature, etc.) on the facility, whether or not the facility is abnormal, and a type of failure (indoor unit failure, output unit failure, network error, etc.) at the same time.

On the other hand, the display unit 1-2 may provide a screen capable of selecting facilities for each group using a user's selection input (selection input through an “Fa” region), and display only graphic objects selected according to the user's selection input through this on the screen.

Furthermore, the display unit 1-2 may preferably display (Fb) a number of facilities for each type of failure on the selected group in a portion of the screen, thereby providing various information to the user.

Furthermore, in order to receive a control command from the user while individually or collectively controlling facilities corresponding to at least one graphic object selected according to a user selection input among graphic objects displayed on the display unit 1-2, icons or the like corresponding to various control commands may be disposed in one portion (CP) of the screen.

However, when a graphic object corresponding to a facility is displayed in a list format through the display unit 1-2 as illustrated in FIG. 6, there is a problem that an administrator is unable to recognize an accurate location for facilities (F1, F2) in which a failure has occurred and their check is required.

In other words, the administrator may recognize that there is a network error in one indoor unit in a second notebook zone in a second reading room on the fourth floor of library through a screen as shown in FIG. 6 (particularly, a graphic object of F2), but cannot accurately recognize at which position of the second notebook zone an indoor unit corresponding to F2 is accurately located.

Accordingly, according to an embodiment disclosed in the present disclosure, the display unit 1-2 displays a graphic object corresponding to the facility on a design drawing for the control site.

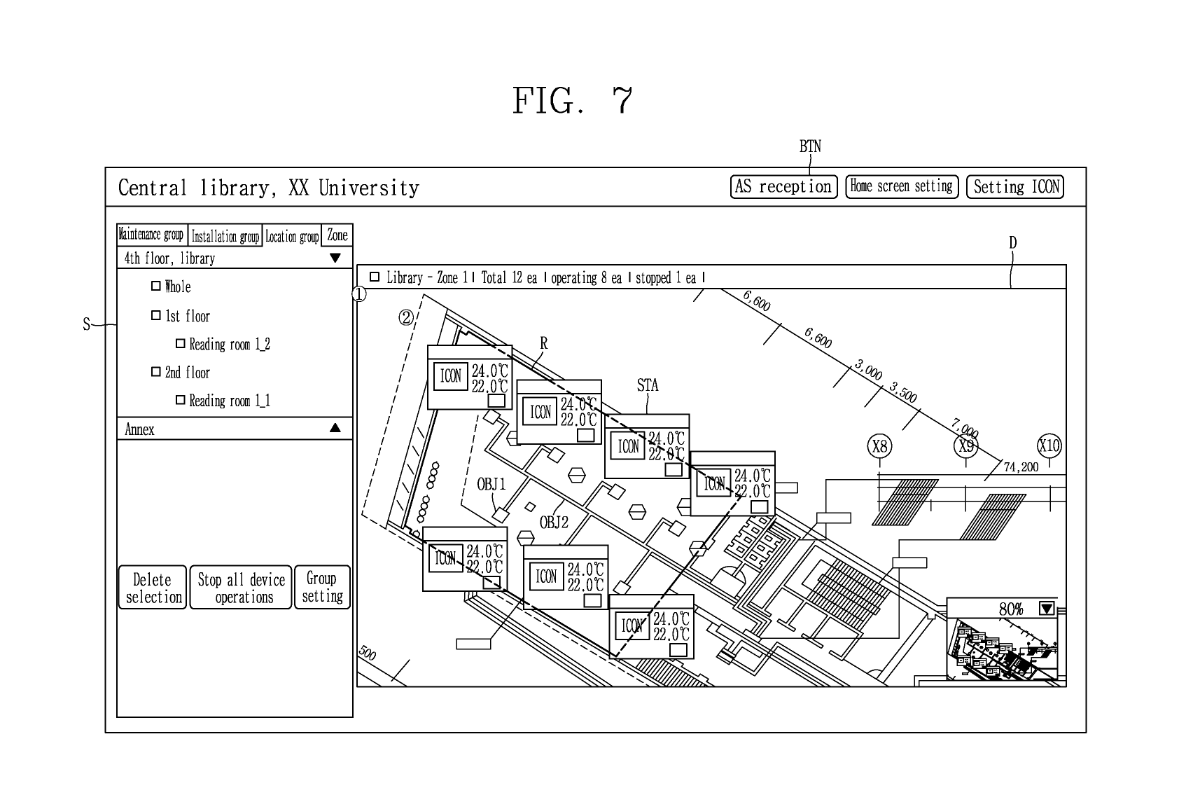

FIG. 7 is a view illustrating a screen displayed with a design drawing for a control site and a graphic object corresponding to a facility according to an embodiment disclosed in the present disclosure.

As illustrated in FIG. 7, the display unit 1-2 may display a design drawing (D) for a first zone of library for the control site, and additionally display a graphic object (OBJ1) corresponding to an indoor unit which is the facility at a specific position on the design drawing (D).

In this manner, the graphic object (OBJ1) may be displayed at a specific position on the design drawing (D) through the display unit 1-2, thereby allowing the administrator to accurately recognize a position at which the facility is installed in the control site.

Furthermore, the controller 1-4 may receive the status information of the facility 200 corresponding to the graphic object through the communication unit 1-3 and display it on the display unit 1-2.

Here, the controller 1-4 may periodically receive the status of the facility 200 through the communication unit 1-3 in a predetermined time interval to display it on the display unit 1-2, but the predetermined time period may be preferably set in a variable manner according to an operation mode of the facility 200, whether or not it is controlled or the like, thereby allowing the remote maintenance server 1 to receive the status information of the facility 200 and store the received status information.

In other words, in order to reduce communication traffic between the remote maintenance server 1 and the facility 200, for example, when an indoor unit is not operated, the remote maintenance server 1 may preferably receive status information with a longer period than that of cooling mode since there is little change in indoor temperature and power consumption for the control region compared to when the indoor unit is in a cooling mode.

The reader unit 1-6 reads a program instruction received by the remote maintenance server 1 through various storage media and communication media.

The controller 1-4 may read a program instruction including information on a design drawing of the control site and the facility, and extract information on the design drawing and the facility from the program instruction.

Here, an example of “the information on the facility” may include a location of the facility installed at the control site (or a facility location on a design drawing for the control site), a type of facility (indoor unit, output unit, ventilator, etc.), a model name of the facility, an identifier (ID) or name of the facility, failure information of the facility (a failure code of the facility (C1: unstable supply power, C2: heat, C3, refrigerant overcharge, etc.), whether or not the network is abnormal, and the like).

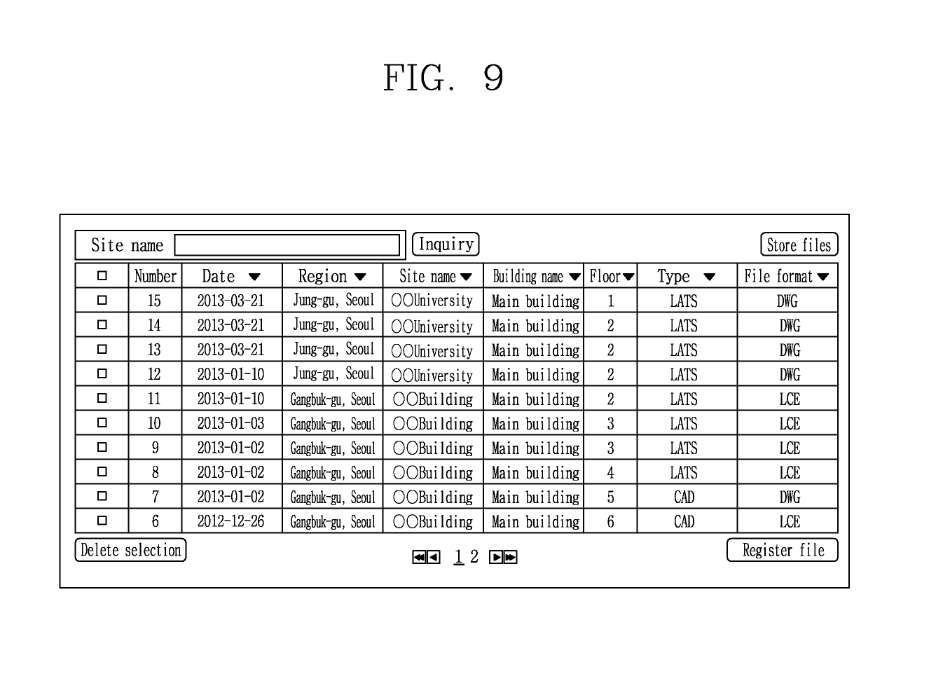

The administrator may maintain a design drawing and information on the facility for each control site through the remote maintenance server 1 as illustrated in FIG. 9.

When a control site controlled by the remote maintenance server 1 is added or deleted, the administrator may additionally store information on a new design drawing and facility or delete information on a prestored design drawing and facility.

Here, the controlled control site may be irrelevant to a number of design drawings, and one maintenance unit may include information on a plurality of design drawings and facilities corresponding to them.

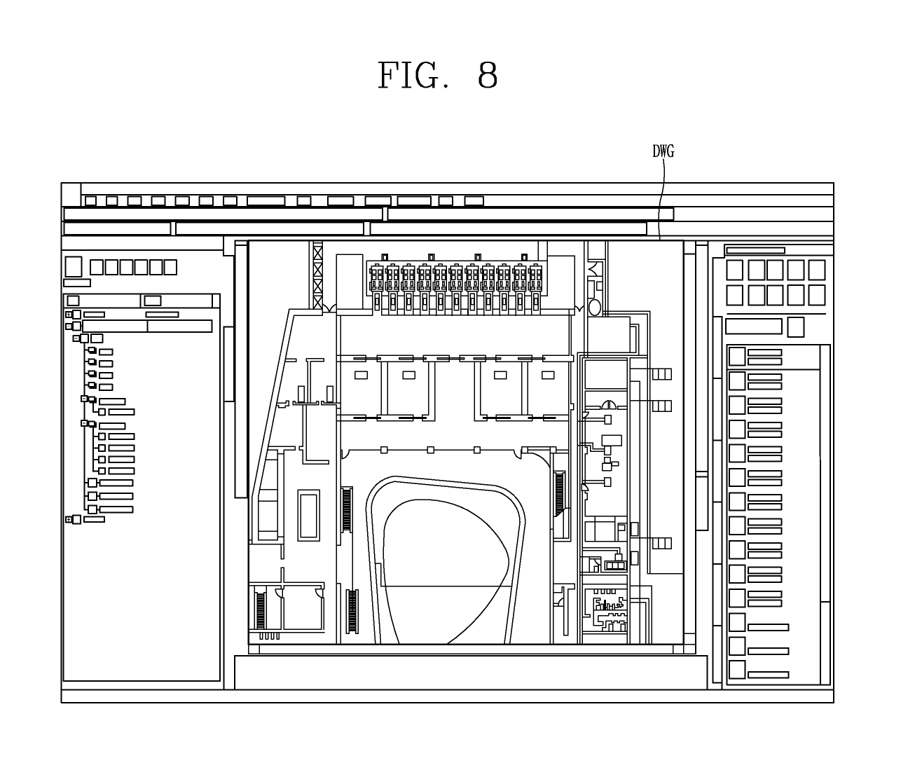

As illustrated in DWG of FIG. 8, a program instruction including information on a design drawing for the controlled control site and the facilities may be stored in a LATS CAD format, which is independently developed by our company, in addition to a typical CAD format.

In other words, in case of a typical CAD format, as illustrated in FIG. 9, an additional file in which information on facilities are stored may further be required in addition to a design drawing file for the control site, and here, the information on facilities may be stored in a file format with the same type of spread sheet, but preferably stored in a mark-up language (refer to the following reference

```
[Reference 1]
  <body> CAD Data
  <site> School </site>
  <ODU_Name> ODU_1 </ODU_Name>
  <X_Y_Axis> 115,255 </X_Y_Axis>
    .
    .
    .
```

As will be described later, when the terminal 40 or remote maintenance server 1 displays a graphic object corresponding to the facility 200 at a specific location on a design drawing of the control site through a web browser, the process of converting information on facilities can be omitted.

As described above, a program instruction including information on the design drawing and the facilities may be stored in two files, but in case of a LATS CAD format, which is independently developed by our company, information on the facilities may be additionally stored in one design drawing file, and thus they can be implemented with one file.

On the other hand, as illustrated in FIG. 7, when displaying graphic objects corresponding to facilities on a design drawing of the control site through the display unit 1-2, the controller 1-4 according to an embodiment disclosed in the present disclosure may preferably convert information extracted from a program instruction including the design drawing and information on facilities to be displayed through a web browser.

Moreover, in order to display the design drawing and graphic objects for facilities on a web browser without using a plug-in to allow a design program such as CAD to be operated on the web browser, the design drawing and each of graphic objects for the facilities may be converted into an image file (jpg, bmp, png, etc.), and information on the facilities may be converted into a mark-up language format that can be read on the web browser to allow the location of the graphic objects for the facilities on the design drawing to follow the information on the facilities.

Here, the remote maintenance server 1 according to an embodiment disclosed in the present disclosure may edit a graphic object corresponding to the facility or a pipe connected between or facilities through the input unit 1-1.

In other words, when there is an error in the location of the graphic object for a facility read by the remote maintenance server 1 or information on the facility, the administrator may be preferably allowed to generate a new graphic object or delete the graphic object that has been generated or modify the information on the facility.

Here, editing for the graphic object and/or information on the facility as described above may be of course implemented on a web browser.

On the other hand, as illustrated in FIG. 7, when displaying a graphic object corresponding to a facility on a design drawing of the control site through the display unit 1-2, the administrator may individually select a graphic object or select graphic objects for each group or the whole graphic objects in one portion (“S” region) of the screen to transmit a control command to the facility 200 corresponding to the graphic object according to a user input or preset schedule.

For an example, when a selection input to a graphic object of OBJ1 is received from the administrator, the controller 1-4 may change an operation mode or reset a desired temperature in an indoor unit corresponding to the selected OBJ1.

Here, the controller 1-4 may store a control command set according to a schedule in the storage unit 1-5, thereby allowing a preset control command to be transmitted to the facility 200 in a predetermined time interval or allowing a preset control command to be transmitted to the facility 200 at a specific time.

On the other hand, the controller 1-4 may determine whether or not the facility is abnormal based on the status information of the facility received through the communication unit 1-3.

A method of allowing the controller 1-4 to determine whether or not the facility is abnormal may be carried out in accordance with a publicly known method, but, for an example, a failure code received from the facilities 200 may be recognized to determine whether or not the relevant facility is abnormal or a cause of failure, and for another example, their failure may be determined when various status information received from the facilities 200 are out of preset normal reference range values.

Here, the controller 1-4 may transmit information on a facility determined to be in an abnormal state to a service center server (not shown) through the communication unit 1-3 or display information on the abnormal facility through the display unit 1-2 according to an administrator's request.

Furthermore, the controller 1-4 may determine whether or not the facility 200 is abnormal based on status information or failure code received from the facility 200, but on the contrary, may set a facility selected by an external input from the administrator through the input unit 1-1 to an abnormal facility. In other words, the administrator may determine whether or not it corresponds to an abnormal facility based on various status information on facilities received through the remote maintenance server 1 to set it to an abnormal facility.

On the other hand, the storage unit 1-5 may be a device for storing data received from the facility 200 through the communication unit 1-3, a result processed by the controller 1-4, and the like.

Here, various status information on the facilities 200 may be stored in the local controller 100, but the local controller 100 may be typically implemented as a system having a limited resource, and thus there is a limit in the storage space, thereby having a problem in which status information history stored therein is restricted to a short period of time.

However, the remote maintenance server 1 may receive and store various status information on the facilities 200 through the local controller 100 to archive status information history for a long period of time, and allow the controller 1-4 to determine whether or not the facility is abnormal based on a variation trend of the relevant status information for a long period of time or a comparison with the relevant status information in a similar environment in the past, thereby enhancing accuracy while determining whether or not there is abnormality.

As described above, a graphic object corresponding to the facility may be displayed and the status information of a facility corresponding to the graphic object may be displayed on a design drawing of the control site through the display unit 1-2.

However, since the status information of the facility may typically display a current temperature, a desired temperature or the like with text as illustrated in FIG. 7, it is difficult for the administrator to recognize the whole status information of a plurality of facilities.

Accordingly, when receiving status information from the facility 200 through the communication unit 1-3 and displaying it on the display unit 1-2, it may be preferable to display a graphic object corresponding to the relevant facility according to the status information.

According to an embodiment, when a facility corresponding to the graphic object is an abnormal facility in which a failure has occurred, it may be preferable to display a graphic object in a different attribute from that of a graphic object corresponding to the same type of facility.

For an example, as illustrated in FIG. 7, when there are a plurality of graphic objects indicating indoor units, it is assumed that a failure has occurred on an indoor unit corresponding to OBJ1 among a plurality of indoor units.

Here, the display unit 1-2 may display the graphic object, OBJ1, corresponding to an abnormal facility in a different color or different size from that of a graphic object corresponding to the same type of facility, or display the color or size of the graphic object to be changed with time, or display the graphic object, OBJ1, corresponding to the abnormal facility to blink, and when monitoring the whole design drawing, the administrator may quickly recognize that an abnormal facility has occurred among the plurality of facilities 200 as well as at which position the failed facility is disposed.

Even when a graphic object is displayed in a list format, a status indicator indicating that a failure has occurred on a graphic object (F1, F2) corresponding to the facility may be of course displayed (refer to FIG. 6).

In this case, in order for the administrator to request post-processing for a facility in which a failure has occurred, the remote maintenance server 1 may receive a post-processing reception request through an AS reception button (BTN).

Accordingly, the remote maintenance server 1 may request post-processing for the facility selected by the administrator. Here, the remote maintenance server 1 may transmit a message in an e-mail or SMS format to a repairman's terminal (not shown), or generate an alarm using a specific signal or vibration according to a type of the selected facility for which post-processing has been requested.

When the remote maintenance server 1 transmits a post-processing request to a repairman's terminal (not shown), the remote maintenance server 1 may transmit status information (including a failure code or the like) on an abnormal facility to the repairman's terminal at the same time, and allow the repairman to know a failure cause of the abnormal facility in advance, and prepare components required to repair the abnormal facility in advance, thereby allowing the repairman not to repeatedly visit the abnormal facility.

Furthermore, the remote maintenance server 1 may store information on contacts, professional repair fields, and the like for a plurality of repairman's terminals (not shown) in the storage unit 1-5, and thus it may be preferable to transmit a post-processing request to a repairman's terminal corresponding to the professional repair field according to the type of abnormal facility.

As described above, the remote maintenance server 1 may directly transmit a message to a repairman's terminal (not shown) upon receiving a post-processing request, but transmit a post-processing request and the status information of an abnormal facility to a separate service center server (not shown), thereby allowing the service center server to perform a post-processing request to the relevant repairman's terminal.

On the other hand, the remote maintenance server 1 may read a program instruction received through various storage media or communication media using the reader unit 1-6, and here, the program instruction may include a design drawing of a control site and information on a facility as described above.

However, a program instruction according to according to an embodiment disclosed in the present disclosure may further include information on a control zone corresponding to a facility in the control site.

Accordingly, the controller 1-4 may read information on the control zone using the reader unit 1-6, and the display unit 1-2 may display the control zone on the design drawing.

Control zone among terms used in the present disclosure denotes a zone in which an indoor unit conditions air as a zone in which the facility is operated by a control command to exert an effect thereon. For an example, control zone “R” illustrated in FIG. 7 is a zone in which the indoor unit (OBJ1) provides cooling or heating capacity according to a control command.

Here, the remote maintenance server 1 may calculate a thermal load on the control zone “R”, and display the calculated thermal load through the display unit 1-2. Here, a method of calculating a thermal load may be carried out using a publicly known method, and the detailed description thereof will be omitted since the description of various method for calculating a thermal load is out of the scope of the present invention.

Here, the controller 1-4 may calculate a time required to reach a desired set temperature from a current temperature, an amount of power consumption consumed by a facility installed in the control zone, or the like, based on a thermal load on the control zone “R”, an amount of heat provided by the facility (OBJ1 or the like) installed in the control zone “R”, and the like, and display them on the display unit 1-2 for the administrator.

On the other hand, when displaying a graphic object corresponding to a facility through the display unit 1-2, the remote maintenance server 1 according to an embodiment disclosed in the present disclosure may preferably display a graphic object corresponding to a pipe connected between a plurality of facilities at the same time.

Accordingly, information on a facility extracted from a program instruction by the controller 1-4 using the reader unit 1-6 may include information on a pipe connected between facilities other than the information on the facility.

Here, an example of the “information on a pipe” may include a length of pipe, an inner diameter of pipe, a number of branch points, a distance between branch points, a number of facilities connected to a pipe, and the like.

On the other hand, the remote maintenance server 1 according to an embodiment disclosed in the present disclosure may display a graphic object corresponding to a facility on a design drawing of the control site through the display unit 1-2, but there may be a problem that a connection relation between a plurality of facilities cannot be easily found by the design drawing.

In order to solve the problem, the remote maintenance server 1 according to an embodiment disclosed in the present disclosure may display a schematic diagram showing a connection relation between a plurality of the facilities excluding a design drawing for the control site.

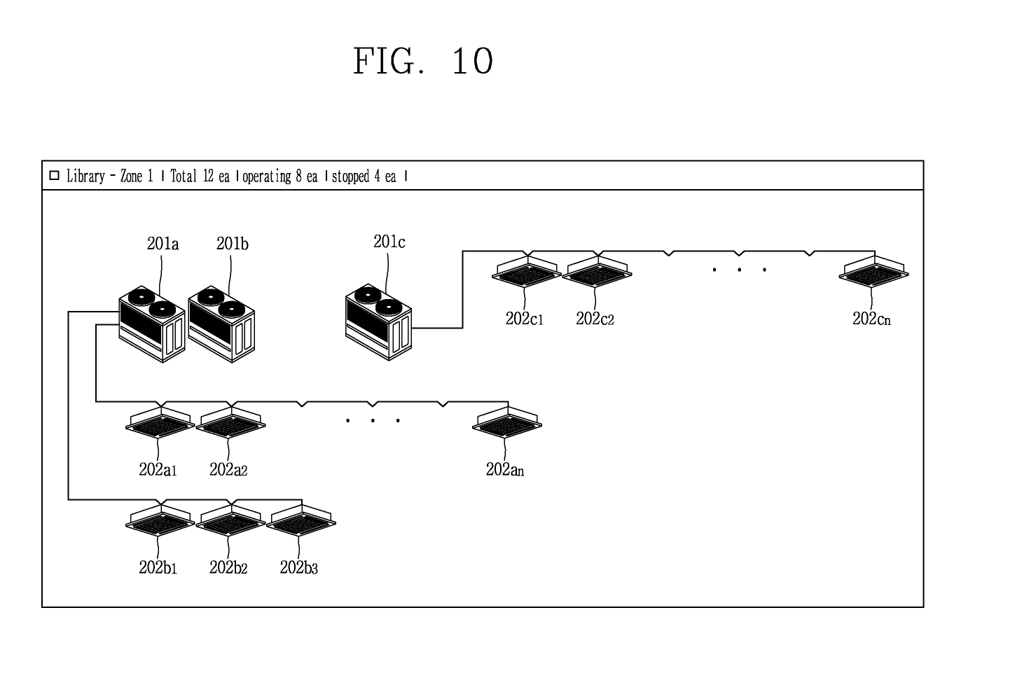

For an example, as illustrated in FIG. 10, a schematic diagram for an indoor unit group (202a1, 202a2, . . . 202an, 202b1, 202b2, 202b3/202c1, 202c2, . . . 202cn) connected to a plurality of output unit groups (201a, 201b/201c), respectively.

Terminal Connected to Remote Maintenance Server

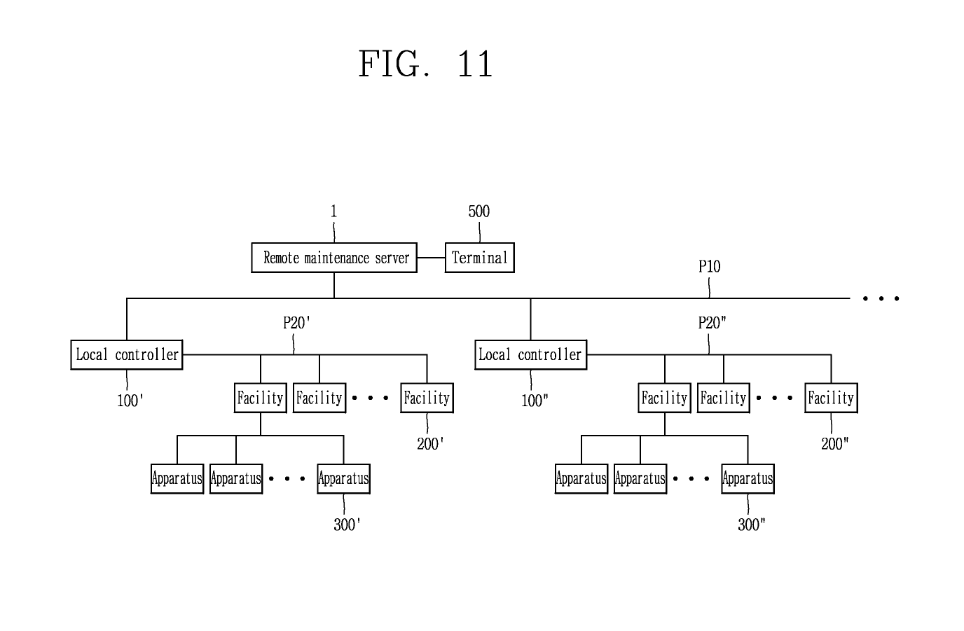

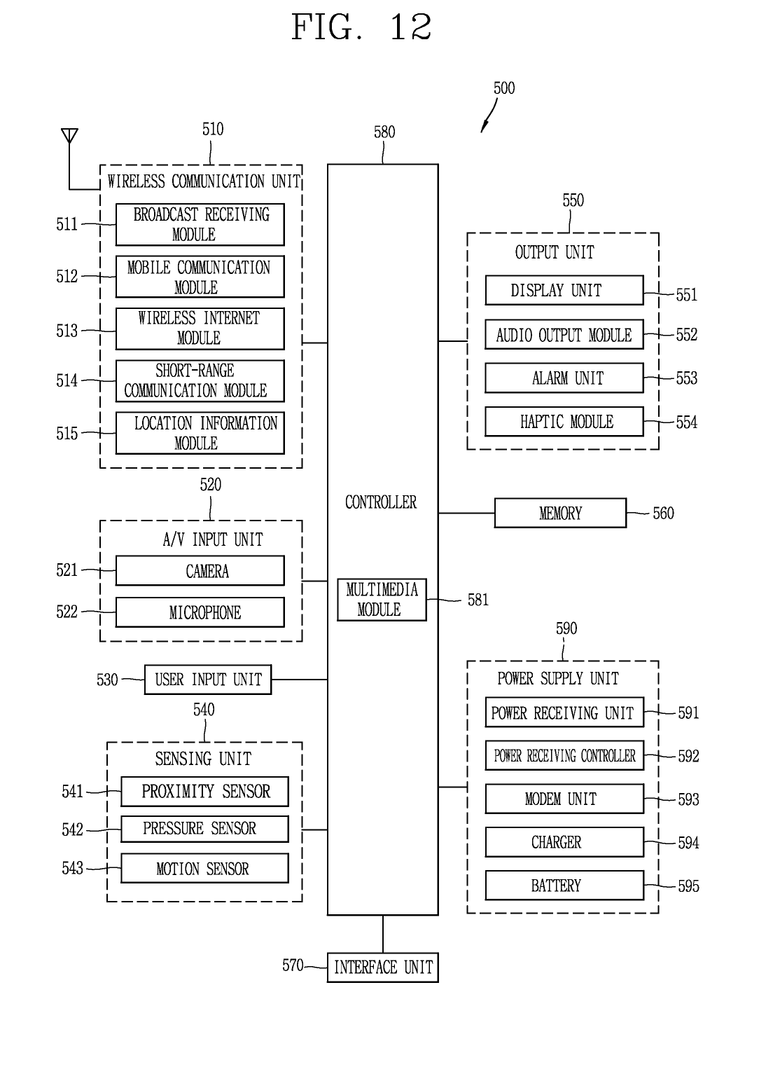

Hereinafter, a remote maintenance function through an external terminal connected to a remote maintenance server according to an embodiment will be described in detail with reference to FIGS. 11 and 12.

A remote maintenance function according to an embodiment disclosed herein may be implemented in part or a combination of the components or steps included in the foregoing embodiments or may be implemented in a combination of the foregoing embodiments, and hereinafter, overlapping portions may be omitted for clarity of the embodiment of a remote maintenance function through a terminal according to an embodiment.

FIG. 11 is an exemplary view illustrating an external terminal connected to a remote maintenance server according to an embodiment disclosed in the present disclosure.

Referring to FIG. 11, the remote maintenance server 1 according to an embodiment disclosed in the present disclosure may be connected to a terminal 40 in a wired or wireless manner.

For the purpose of this, the remote maintenance server 1 may be connected to the terminal 500 through the foregoing communication unit 1-3.

Here, the remote maintenance server 1 and the terminal 500 may perform communication in at least one communication mode or communication protocol of a mobile communication network, Transmission Control Protocol/Internet Protocol (TCP/IP), Local Area Network (LAN), Wireless LAN, Wi-Fi, Wireless Broadband (Wibro) and World Interoperability for Microwave Access (Wimax).

The terminal 500 connected to the remote maintenance server 1 may receive various control commands for the facilities 200 from a user or display the status information of various facilities 200.

Here, the type of the terminal 500 may not be necessarily limited, but hereinafter, it will be described by assuming that the terminal 500 is implemented in the form of a mobile terminal, and the mobile terminal is referred to as reference numeral 500 for easy explanation.

According to an embodiment disclosed in the present disclosure, the remote maintenance server 1 reads a program instruction including a design drawing of a control site and information on facilities through a storage medium or communication medium through the reader unit 1-6, and the controller 1-4 extracts the design drawing of a control site and the information on facilities from the program instruction that has been read through the reader unit 1-6, and transmits the extracted information to the terminal 500, thereby allowing the terminal 500 to display the design drawing and the information on facilities.

In addition, the terminal 500 may display a graphic object corresponding to a pipe connected between facilities.

In this manner, in order to allow the terminal 500 to display information on the design drawing and facilities through a web browser, the controller 1-4 of the remote maintenance server 1 may convert the information on a design drawing and facilities of the control site extracted from a program instruction to be displayed through the web browser, and transmit the converted information to the terminal 500 through the communication unit 1-3.

Furthermore, in order to display the status information of a facility corresponding to the graphic object in addition to the information on the design drawing and facilities, the terminal 500 may receive the status information of the facility.

Here, the terminal 500 may display the graphic object according to the status information of the facility, and whether or not the facility is abnormal may be determined based on the status of the facility received by the remote maintenance server 1 or terminal 500, and according to a result of the determination, in case of a graphic object corresponding to an abnormal facility, the terminal 500 may display a graphic object corresponding to the abnormal facility in a different attribute from that of a graphic object corresponding to the same type of facility.

According to an embodiment, the terminal 500 may display a graphic object corresponding to the abnormal facility in a different color or different size from that of a graphic object corresponding to the same type of facility, or display the color or size of the graphic object to be changed with time, or display the graphic object to blink.

Furthermore, a program instruction received by the terminal 500 may include information on a control zone corresponding to the facility of the control site, and read information on the control zone from the program instruction, and display the control zone on the design drawing.

Furthermore, the terminal 500 or remote maintenance server 1 may calculate a thermal load on the control zone, and the terminal 500 may display the thermal load on the control zone, and the terminal 500 or remote maintenance server 1 may calculate a time required to reach a desired set temperature from a current temperature, an amount of power consumption consumed by a facility installed in the control zone, or the like, using a thermal load, thereby allowing the terminal 500 to display it.

Furthermore, the terminal 500 may transmit a control command to control the facility corresponding to the graphic object through the remote maintenance server according to a user input to the graphic object or a preset schedule.

The terminal 500 may of course transmit a control command to control the facility corresponding to the graphic object through the remote maintenance server according to a user input, and transmit a preset control command to the facility 200 in a predetermined time interval using a schedule stored in the memory 560 within the terminal 500 or the storage unit 1-5 of the remote maintenance server 1 or transmit a preset control command to the facility 200 at a specific time.

Furthermore, the terminal 500 may displays schematic diagram showing a connection relation between a plurality of the facilities excluding a design drawing for the control site.

Furthermore, the terminal 500 may receive an editing input to the graphic object from a user, and the terminal 500 or remote maintenance server 1 may store information on a facility corresponding to the graphic object edited according to the user input.

In other words, the terminal 500 according to an embodiment disclosed in the present disclosure may remotely access the remote maintenance server 1 to receive a user input or display a design drawing of the control site, graphic objects for facilities or pipes, a schematic diagram, or the like in the same or similar manner to the remote maintenance server 1 described in the foregoing embodiment, and the redundant description thereof will be substituted by the description of the foregoing embodiment, and the detailed description thereof will be omitted.

FIG. 12 illustrates a configuration diagram illustrating the configuration of a terminal connected to a remote maintenance server disclosed in the present disclosure.

The terminal 500 may include a wireless communication unit 110, an audio/video (A/V) input unit 520, a user input unit 530, a sensing unit 540, an output unit 550, a memory 560, an interface unit 570, a controller 580, a power supply unit 590, and the like. However, the constituent elements as illustrated in FIG. 9 are not necessarily required, and the mobile device may be implemented with greater or less number of elements than those illustrated elements.

Hereinafter, the constituent elements will be described in sequence.

The wireless communication unit 510 may typically include one or more elements allowing radio communication between the terminal 500 and a wireless communication system, between radio communication the terminal 500 and a network in which the terminal 500 is located, or between the terminal 500 and the central control device 100.

For example, the wireless communication unit 510 may include a broadcast receiving module 511, a mobile communication module 512, a wireless Internet module 513, a short-range communication module 514, a location information module 515, and the like.

The broadcast receiving module 511 receives broadcast signals and/or broadcast associated information from an external broadcast management server through a broadcast channel.

The broadcast channel may include a satellite channel and/or a terrestrial channel. The broadcast management server may mean a server that generates and transmits a broadcast signal and/or broadcast associated information or a server that receives a previously generated broadcast signal and/or broadcast associated information and transmits to the terminal 500. The broadcast signal may include a TV broadcast signal, a radio broadcast signal and a data broadcast signal as well as a broadcast signal in a form that a data broadcast signal is coupled to the TV or radio broadcast signal.

The broadcast associated information may mean information regarding a broadcast channel, a broadcast program, a broadcast service provider, and the like. The broadcast associated information may also be provided through a mobile communication network, and in this case, the broadcast associated information may be received by the mobile communication module 512.

The broadcast associated information may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 511 may receive a broadcast signal using various types of broadcast systems. In particular, the broadcast receiving module 511 may receive a digital broadcast signal using a digital broadcast system such as digital multimedia broadcasting-terrestrial (DMB-T), digital multimedia broadcasting-satellite (DMB-S), media forward link only (MediaFLO), digital video broadcast-handheld (DVB-H), integrated services digital broadcast-terrestrial (ISDB-T), and the like. The broadcast receiving module 511 is, of course, configured to be suitable for every broadcast system that provides a broadcast signal as well as the above-mentioned digital broadcast systems.

The broadcast signal and/or broadcast-associated information received through the broadcast receiving module 511 may be stored in the memory 560.

The mobile communication module 512 transmits and/or receives a radio signal to and/or from at least one of a base station, an external terminal and a server over a mobile communication network. Here, the radio signal may include a voice call signal, a video call signal and/or various types of data according to text and/or multimedia message transmission and/or reception.

The wireless Internet module 513 means a module for supporting wireless Internet access. The wireless Internet module 513 may be built-in or externally installed to the terminal 500. Here, it may be used a wireless Internet access technique including a WLAN (Wireless LAN), Wi-Fi, Wibro (Wireless Broadband), Wimax (World Interoperability for Microwave Access), HSDPA (High Speed Downlink Packet Access), and the like.

The short-range communication module 514 is a module for supporting a short-range communication. Here, it may be used a wireless short-range communication technology including Bluetooth®, Radio Frequency IDentification (RFID), Infrared Data Association (IrDA), Ultra WideBand (UWB), ZigBee®, and the like. Meanwhile, it may be used a wired short-range communication technology including Universal Serial Bus (USB), IEEE 1394, Thunderbolt™, and the like.

The wireless Internet module 513 or the short-range communication module 514 may establish data communication connection to the central control device 100.

Through the established data communication, when there is an audio signal to be output while transmitting power in a wireless manner, the wireless Internet module 513 or the short-range communication module 514 may transmit the audio signal to the central control device 100 through the short-range communication module. Furthermore, through the established data communication, when there is information to be displayed, the wireless Internet module 513 or the short-range communication module 514 may transmit the information to the central control device 100. Otherwise, through the established data communication, the wireless Internet module 513 or the short-range communication module 514 may receive an audio signal entered through a microphone embedded in the central control device 100. Furthermore, the wireless Internet module 513 or the short-range communication module 514 may transmit the identification information (for instance, phone number or device name in case of a portable phone) of the mobile terminal 500 to the central control device 100 through the established data communication.

The location information module 515 is a module for acquiring a location of the mobile device, and there is a global positioning system (GPS) module as an example.

Referring to FIG. 10, the A/V (audio/video) input unit 520 receives an audio or video signal, and the A/V (audio/video) input unit 520 may include a camera 521 and a microphone 522. The camera 521 processes a image frame, such as still picture or video, obtained by an image sensor in a video phone call or image capturing mode. The processed image frame may be displayed on a display unit 551.

The image frames processed by the camera 521 may be stored in the memory 560 or transmitted to an external device through the wireless communication unit 510. Two or more cameras 521 may be provided according to the use environment of the mobile device.

The microphone 522 receives an external audio signal through a microphone in a phone call mode, a recording mode, a voice recognition mode, and the like, and processes the audio signal into electrical voice data. The processed voice data may be converted and outputted into a format that is transmittable to a mobile communication base station through the mobile communication module 512 in the phone call mode. The microphone 522 may implement various types of noise canceling algorithms to cancel noise generated in a procedure of receiving the external audio signal.

The user input unit 530 may generate input data to control an operation of the terminal. The user input unit 530 may be configured by including a keypad, a dome switch, a touch pad (pressure/capacitance), a jog wheel, a jog switch, and the like.

The sensing unit 540 may include a proximity sensor 541, a pressure sensor 542, a motion sensor 543, and the like. The proximity sensor 541 detects an object approaching the mobile terminal 500, or the presence or absence of an object existing adjacent to the mobile terminal 500, and the like without any mechanical contact. The proximity sensor 541 may detect a proximity object using a change of the AC magnetic field or static magnetic field, a change rate of the electrostatic capacity, or the like. Two or more proximity sensors 541 may be provided according to the aspect of configuration.

The pressure sensor 542 may detect whether or not a pressure is applied to the mobile terminal 500, a size of the pressure, and the like. The pressure sensor 542 may be provided at a portion where the detection of a pressure is required in the mobile terminal 500 according to the use environment. When the pressure sensor 542 is provided in the display unit 551, it may be possible to identify a touch input through the display unit 551 and a pressure touch input by which a pressure larger than the touch input is applied according to a signal outputted from the pressure sensor 542. Furthermore, it may be possible to know a size of the pressure applied to the display unit 551 during the input of a pressure touch.

The motion sensor 543 detects the location or movement of the mobile terminal 500 using an acceleration sensor, a gyro sensor, and the like. The acceleration sensor that can be used in the motion sensor 543 is an element for converting an acceleration change in any one direction into an electrical signal. The acceleration sensor is typically configured by providing two or three axes in a package, and according to the used circumstances there may be a case where only one z-axis is required. Accordingly, when the x-axis or y-axis acceleration sensor is used instead of the z-axis acceleration sensor due to any reason, the acceleration sensor may be provided to be placed upright on a main substrate using a separate piece of substrate. The gyro sensor as a sensor for measuring an angular velocity of the mobile terminal 500 performing a rotational movement may sense a rotated angle with respect to each reference direction. For instance, the gyro sensor may sense each rotated angle with reference to three directional axes, namely, azimuth, pitch and roll.

The output unit 550 is configured to generate an output for visual, auditory or tactile sense, and the output unit 550 may include the display unit 551, an audio output module 552, an alarm unit 553, a haptic module 554, and the like.

The display unit 551 may display (output) information processed in the terminal 500. For example, when the terminal 500 is in a phone call mode, the display unit 551 may display a User Interface (UI) or a Graphic User Interface (GUI) associated with a call. When the terminal 500 is in a video call mode or image capturing mode, the display unit 551 may display a captured image and/or received image, a UI or GUI.

The display unit 551 may include at least one of a Liquid Crystal Display (LCD), a Thin Film Transistor-LCD (TFT-LCD), an Organic Light Emitting Diode (OLED) display, a flexible display, a three-dimensional (3D) display, and an e-ink display.

Some of those displays may be configured with a transparent or optical transparent type to allow viewing of the exterior through the display unit, which may be called transparent displays. An example of the typical transparent displays may include a transparent LCD (TOLED), and the like. Under this configuration, a user can view an object positioned at a rear side of a mobile device body through a region occupied by the display unit 551 of the mobile device body.

Two or more display units 551 may be implemented according to a configured aspect of the terminal 500. For instance, a plurality of the display units 551 may be arranged on one surface to be spaced apart from or integrated with each other, or may be arranged on different surfaces.

When the display unit 551 and a touch sensitive sensor (hereinafter, referred to as a “touch sensor”) have an interlayer structure (hereinafter, referred to as a “touch screen”), the display unit 551 may be used as an input device rather than an output device. The touch sensor may be implemented as a touch film, a touch sheet, a touch pad, and the like.

The touch sensor may be configured to convert changes of a pressure applied to a specific part of the display unit 551, or a capacitance occurring from a specific part of the display unit 551, into electric input signals. Also, the touch sensor may be configured to sense not only a touched position and a touched area, but also a touch pressure.

When there is a touch input to the touch sensor, the corresponding signals are transmitted to a touch controller (not shown). The touch controller processes the received signals, and then transmits corresponding data to the controller 580. Accordingly, the controller 580 may sense which region of the display unit 551 has been touched.

A proximity sensor 541 may be arranged at an inner region of the terminal 500 covered by the touch screen, or near the touch screen. The proximity sensor indicates a sensor to sense presence or absence of an object approaching to a surface to be sensed, or an object disposed near a surface to be sensed, by using an electromagnetic field or infrared rays without a mechanical contact. The proximity sensor has a longer lifespan and a more enhanced utility than a contact sensor.

The proximity sensor may include an optical transmission type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, proximity of a pointer to the touch screen is sensed by changes of an electromagnetic field. In this case, the touch screen (touch sensor) may be categorized into a proximity sensor.

Hereinafter, for the sake of convenience of brief explanation, a status that the pointer is positioned to be proximate onto the touch screen without contact will be referred to as ‘proximity touch’, whereas a status that the pointer substantially comes in contact with the touch screen will be referred to as ‘contact touch’. For the position corresponding to the proximity touch of the pointer on the touch screen, such position corresponds to a position where the pointer faces perpendicular to the touch screen upon the proximity touch of the pointer.

The proximity sensor senses proximity touch, and proximity touch patterns (e.g., distance, direction, speed, time, position, moving status, etc.). Information relating to the sensed proximity touch and the sensed proximity touch patterns may be output onto the touch screen.

The audio output module 552 may output audio data received from the wireless communication unit 510 or stored in the memory 560, in a call-receiving mode, a call-placing mode, a recording mode, a voice recognition mode, a broadcast reception mode, and so on. The audio output module 552 may output audio signals relating to functions performed in the terminal 500, e.g., sound alarming a call received or a message received, and so on. The audio output module 552 may include a receiver, a speaker, a buzzer, and so on.

The alarm 553 outputs signals notifying occurrence of events from the terminal 500. The events occurring from the terminal 500 may include call received, message received, key signal input, touch input, and so on. The alarm 553 may output not only video or audio signals, but also other types of signals such as signals notifying occurrence of events in a vibration manner. Since the video or audio signals can be output through the display unit 551 or the audio output unit 552, the display unit 551 and the audio output module 552 may be categorized into a part of the alarm 553.

The haptic module 554 generates various tactile effects which a user can feel. A representative example of the tactile effects generated by the haptic module 554 includes vibration. Vibration generated by the haptic module 554 may have a controllable intensity, a controllable pattern, and so on. For instance, different vibration may be output in a synthesized manner or in a sequential manner.

The haptic module 554 may generate various tactile effects, including not only vibration, but also arrangement of pins vertically moving with respect to a skin being touched, air injection force or air suction force through an injection hole or a suction hole, touch by a skin surface, presence or absence of contact with an electrode, effects by stimulus such as an electrostatic force, reproduction of cold or hot feeling using a heat absorbing device or a heat emitting device, and the like.

The haptic module 554 may be configured to transmit tactile effects through a user's direct contact, or a user's muscular sense using a finger or a hand. The haptic module 554 may be implemented in two or more in number according to the configuration of the terminal 500.

The memory 560 may store a program for processing and controlling the controller 580. Alternatively, the memory 560 may temporarily store input/output data (e.g., phonebook data, messages, audios, still images, videos, and the like). Also, the memory 560 may store data related to various patterns of vibrations and sounds outputted upon the touch input on the touch screen.

In some embodiments, software components including an operating system (not shown), a module performing a function of the wireless communication unit 510, a module operated along with the user input unit 530, a module operated along with the A/V input unit 520, and a module operated along with the output unit 550. The operating system (for example, LINUX, UNIX, OS X, WINDOWS, Chrome, Symbian, iOS, Android, VxWorks, or other embedded systems) may include various software components and/or drivers for controlling system tasks such as memory management, power management, and the like.

Furthermore, the memory 560 may store a program (for example, control program) associated with the control or maintenance of a facility. The program may be carried out by the controller 580.

Furthermore, the memory 560 may store an application associated with the control or maintenance of a facility downloaded from an application providing server (for example, app store).

The memory 560 may be implemented using any type of suitable storage medium including a flash memory type, a hard disk type, a multimedia card micro type, a memory card type (e.g., SD or DX memory), Random Access Memory (RAM), Static Random Access Memory (SRAM), Read-Only Memory (ROM), Electrically Erasable Programmable Read-only Memory (EEPROM), Programmable Read-only Memory (PROM), magnetic memory, magnetic disk, optical disk, and the like. Also, the terminal 500 may operate a web storage which performs the storage function of the memory 560 on the Internet.

The interface unit 570 may generally be implemented to interface the mobile device with external devices. The interface unit 570 may allow a data reception from an external device, a power delivery to each component in the terminal 500, or a data transmission from the terminal 500 to an external device. The interface unit 570 may include, for example, wired/wireless headset ports, external charger ports, wired/wireless data ports, memory card ports, ports for coupling devices having an identification module, audio Input/Output (I/O) ports, video I/O ports, earphone ports, and the like.

The identification module may be configured as a chip for storing various information required to authenticate an authority to use the terminal 500, which may include a User Identity Module (UIM), a Subscriber Identity Module (SIM), and the like. Also, the device having the identification module (hereinafter, referred to as ‘identification device’) may be implemented in a type of smart card. Hence, the identification device can be coupled to the terminal 500 via a port.

The interface unit may serve as a path for power to be supplied from an external cradle to the terminal 500 when the terminal 500 is connected to the external cradle or as a path for transferring various command signals inputted from the cradle by a user to the terminal 500. Such various command signals or power inputted from the cradle may operate as signals for recognizing that the mobile device has accurately been mounted to the cradle.

The controller 580 typically controls the overall operations of the terminal 500. For example, the controller 580 performs the control and processing associated with telephony calls, data communications, video calls, and the like. Furthermore, the controller 580 may include a multimedia module 581 which provides multimedia playback. The multimedia module 581 may be configured as part of the controller 580 or as a separate component.

The controller 580 can perform a pattern recognition processing so as to recognize writing or drawing input on the touch screen as text or image.

The power supply unit 590 receives external power and internal power under the control of the controller 580 to supply power required by various components.

The power supply unit 590 may be provided with a battery 599 configured to supply power to various elements of the terminal 500, and may include a charger 598 for charging the battery 599 in a wired or wireless manner.

Though the present disclosure discloses a mobile terminal connected to the central control device 100 as an example, it may be easily understood by those skilled in the art that the configuration according to the exemplary embodiments of this specification can also be applied to a stationary terminal such as a digital TV, a desktop computer and the like, excluding a case of being applicable only to the mobile terminal.

The scope of the present invention may not be limited to those specific embodiments, and various modifications, variations, and improvements can be made without departing from the concept of the invention, and within the scope of the appended claims.

Remote Maintenance Method

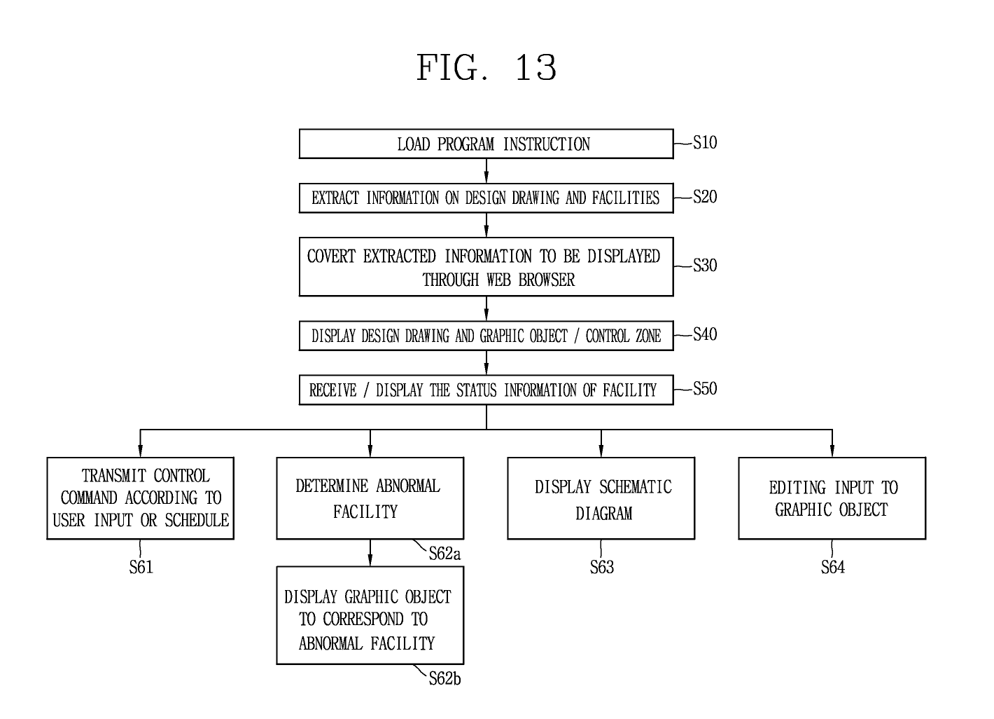

FIG. 13 is a step-by-step flow chart illustrating a remote maintenance method according to an embodiment of the present disclosure.

Hereinafter, the method will be described for each step, and their redundant description will be substituted by the earlier description, and the detailed description thereof will be omitted.

As illustrated in FIG. 13, a remote maintenance method according to an embodiment disclosed in the present disclosure may include allowing the remote maintenance server 1 to read a program instruction comprising information on a design drawing for a control site and information on a facility 200 installed in the control site (S10), allowing the remote maintenance server 1 to extract information on the design drawing and on the facility from the program instruction (S20), allowing the remote maintenance server 1 to convert information extracted from the program instruction to be displayed through a web browser (S30), allowing the remote maintenance server 1 to display a design drawing for a control site and a graphic object corresponding to the facility 200 installed at the control site (S40), and allowing the remote maintenance server 1 to receive and display the status information of a facility corresponding to the graphic object (S50).

Hereinafter, taking each step thereof into consideration, according to the steps of S10 and S20, the remote maintenance server 1 reads a program instruction received through various storage media or communication media using the reader unit 1-6, and extracts information on the design drawing and the facility from the program instruction.

The controller 1-4 may read a program instruction including information on a design drawing and facilities of the control site through the reader unit 1-6, and extract information on the design drawing and facilities (for example, a location of the facility installed at the control site (or a facility location on a design drawing for the control site), a type of facility (indoor unit, output unit, ventilator, etc.), a model name of the facility, an identifier (ID) or name of the facility, failure information of the facility (a failure code of the facility (C1: unstable supply power, C2: heat, C3, refrigerant overcharge, etc.), whether or not the network is abnormal, and the like) from the program instruction.

Here, a program instruction in which a design drawing for a control site and information on facilities are stored may be stored in a CAD or LATS format.

In case of CAD, an additional file in which information on facilities are stored may further be required in addition to a design drawing file for the control site, and here, the information on facilities may be stored in a file format with the same type of spread sheet, but preferably stored in a mark-up language. As will be described later, it is because the process of converting information on facilities can be omitted when the terminal 40 or remote maintenance server 1 displays a graphic object corresponding to the facility 200 at a specific location on the design drawing of the control site through a web browser.

Furthermore, in case of LATS CAD, information on the facilities may be additionally stored in one design drawing file, and thus they can be implemented with one file.

Then, the method may further include allowing the remote maintenance server 1 to convert information extracted from the program instruction to be displayed through a web browser (S30).

During the step of converting the extracted information (S30), in order to display the design drawing and graphic objects for facilities on a web browser without using a plug-in to allow a design program such as CAD to be operated on the web browser, the controller 1-4 may convert the design drawing and each of graphic objects for the facilities that have been read through the reader unit 1-6 into an image file (jpg, bmp, png, etc.), and convert information on the facilities into a mark-up language format that can be read on the web browser to allow the location of the graphic objects for the facilities on the design drawing to follow the information on the facilities.

Then, the remote maintenance server 1 displays a design drawing for a control site and a graphic object corresponding to the facility installed at the control site (S40).

As illustrated in FIG. 7, the display unit 1-2 may display a design drawing (D) for a first zone of library (zone 1) which is a control site, and additionally display a graphic object (OBJ1) corresponding to an indoor unit which is a facility at a specific position on the design drawing (D).

In this manner, the graphic object (OBJ1) may be displayed at a specific position on the design drawing (D) through the display unit 1-2, thereby allowing the administrator to accurately recognize a position at which the facility is installed in the control site.

Furthermore, when displaying a graphic object corresponding to a facility through the display unit 1-2, the remote maintenance server 1 may preferably display a graphic object corresponding to a pipe connected between a plurality of facilities at the same time.

Accordingly, information on a facility extracted from a program instruction by the controller 1-4 using the reader unit 1-6 may include information on a pipe connected between facilities other than the information on the facility (for example, a length of pipe, an inner diameter of pipe, a number of branch points, a distance between branch points, a number of facilities connected to a pipe, etc).

Here, according to an embodiment disclosed in the present disclosure, a program instruction may further include information on a control zone corresponding to a facility on the control site, and the controller 1-4 may read information on the control zone using the reader unit 1-6, and the display unit 1-2 may display the control zone on the design drawing.

For an example, as illustrated in FIG. 7, the display unit 1-2 may display a control zone “R” in which the indoor unit (OBJ1) provides cooling or heating capacity according to a control command on a design drawing for the control site.

Here, the remote maintenance server 1 may calculate a thermal load on the control zone “R”, and display the calculated thermal load through the display unit 1-2.

Here, the controller 1-4 may calculate a time required to reach a desired set temperature from a current temperature, an amount of power consumption consumed by a facility installed in the control zone, or the like, based on a thermal load on the control zone “R”, an amount of heat provided by the facility (OBJ1 or the like) installed in the control zone “R”, and the like, and display them on the display unit 1-2 for the administrator.

Furthermore, the remote maintenance server 1 receives the status information of a facility corresponding to the graphic object and display it (S50).

In other words, the controller 1-4 receives the status information of the facility 200 corresponding to the graphic object through the communication unit 1-3, and displays the received status information on the display unit 1-2.

Here, the controller 1-4 may periodically receive the status of the facility 200 through the communication unit 1-3 in a predetermined time interval to display it on the display unit 1-2, but the predetermined time period may be preferably set in a variable manner according to an operation mode of the facility 200, whether or not it is controlled or the like, thereby allowing the remote maintenance server 1 to receive the status information of the facility 200 and store the received status information.

In other words, in order to reduce communication traffic between the remote maintenance server 1 and the facility 200, for example, when an indoor unit is not operated, the remote maintenance server 1 may preferably receive status information with a longer period than that of cooling mode since there is little change in indoor temperature and power consumption for the control region compared to when the indoor unit is in a cooling mode.

A remote maintenance method according to an embodiment disclosed in the present disclosure may further include transmitting a control command to the facility corresponding to the graphic object according to a user input to the graphic object or a preset schedule (S61).

As illustrated in FIG. 7, when displaying a graphic object corresponding to a facility on a design drawing of the control site through the display unit 1-2, the administrator may individually select a graphic object or select graphic objects for each group or the whole graphic objects in one portion (“S” region) of the screen to transmit a control command to the facility 200 corresponding to the graphic object according to a user input or preset schedule.

For an example, when a selection input to a graphic object of OBJ1 is received from the administrator, the controller 1-4 may change an operation mode or reset a desired temperature in an indoor unit corresponding to the selected OBJ1.

Here, the controller 1-4 may store a control command set according to a schedule in the storage unit 1-5, thereby allowing a preset control command to be transmitted to the facility 200 in a predetermined time interval or allowing a preset control command to be transmitted to the facility 200 at a specific time.

Furthermore, a remote maintenance method according to an embodiment disclosed in the present disclosure may further include allowing the remote maintenance server 1 to determine an abnormal facility among the facilities (S62a), and allowing the remote maintenance server to display a graphic object corresponding to the abnormal facility in a different attribute from that of a graphic object corresponding to the same type of facility when a facility corresponding to the graphic object is an abnormal facility (S62b).

The description of a method of determining an abnormal facility among a plurality of facilities 200 will be substituted by the corresponding description of the foregoing embodiment, and the detailed description thereof will be omitted.

As illustrated in FIG. 7, assuming that a failure has occurred on an indoor unit corresponding to OBJ1 among a plurality of indoor units when there are a plurality of graphic objects indicating indoor units, the display unit 1-2 may display the graphic object, OBJ1, corresponding to an abnormal facility in a different color or different size from that of a graphic object corresponding to the same type of facility, or display the color or size of the graphic object to be changed with time, or display the graphic object, OBJ1, corresponding to the abnormal facility to blink, and when monitoring the whole design drawing, the administrator may quickly recognize that an abnormal facility has occurred among the plurality of facilities 200 as well as at which position the failed facility is disposed.

Even when a graphic object is displayed in a list format, a status indicator indicating that a failure has occurred on a graphic object (F1, F2) corresponding to the facility may be of course displayed (refer to FIG. 6).

Here, in order for the administrator to request post-processing for a facility in which a failure has occurred, the remote maintenance server 1 may receive a post-processing reception request through an AS reception button (BTN), and accordingly, the remote maintenance server 1 may request post-processing for the facility selected by the administrator.

In other words, the remote maintenance server 1 may transmit a message in an e-mail or SMS format to a repairman's terminal (not shown), or generate an alarm using a specific signal or vibration according to a type of the selected facility for which post-processing has been requested.

Here, when the remote maintenance server 1 transmits a post-processing request to a repairman's terminal (not shown), the remote maintenance server 1 may preferably transmit status information (including a failure code or the like) on an abnormal facility to the repairman's terminal at the same time, thereby allowing the repairman to know a failure cause of the abnormal facility in advance.

As described above, the remote maintenance server 1 may directly transmit a message to a repairman's terminal (not shown) upon receiving a post-processing request, but transmit a post-processing request and the status information of an abnormal facility to a separate service center server (not shown), thereby allowing the service center server to perform a post-processing request to the relevant repairman's terminal.

On the other hand, a remote maintenance method according to an embodiment disclosed in the present disclosure may further include displaying a schematic diagram showing a connection relation between a plurality of the facilities excluding a design drawing for the control site (S63).

A graphic object corresponding to a facility may be displayed on a design drawing of the control site through the display unit 1-2, but there may be a problem that a connection relation between a plurality of facilities cannot be easily found by the design drawing.

In order to solve the problem, the remote maintenance server 1 according to an embodiment disclosed in the present disclosure may display a schematic diagram showing a connection relation between a plurality of the facilities excluding a design drawing for the control site.

For an example, as illustrated in FIG. 10, a schematic diagram for an indoor unit group (202a1, 202a2, . . . 202an, 202b1, 202b2, 202b3/202c1, 202c2, . . . 202cn) connected to a plurality of output unit groups (201a, 201b/201c), respectively.

On the other hand, a remote maintenance method according to an embodiment disclosed in the present disclosure may further include receiving an editing input to a graphic object corresponding to the facility or a pipe connected between facilities through the input unit 1-1 (S64).

When there is an error in the location of the graphic object for a facility read by the remote maintenance server 1 or information on the facility, the administrator may be preferably allowed to generate a new graphic object or delete the graphic object that has been generated or modify the information on the facility.

Here, editing for the graphic object and/or information on the facility as described above may be of course implemented on a web browser.

On the other hand, a remote maintenance method according to an embodiment disclosed in the present disclosure may use a remote maintenance system including a remote maintenance server configured to remotely control facilities and a terminal connected to the remote maintenance server in a communicable manner.

According to an embodiment disclosed in the present disclosure, the remote maintenance server 1 reads a program instruction including a design drawing of a control site and information on facilities through a storage medium or communication medium through the reader unit 1-6, and the controller 1-4 extracts the design drawing of a control site and the information on facilities from the program instruction that has been read through the reader unit 1-6, and transmits the extracted information to the terminal 500, thereby allowing the terminal 500 to display the design drawing and the information on facilities.

In addition, the detailed description of a method of allowing the terminal 500 to communicate with the remote maintenance server 1 to receive an input from the user or display it through the display unit or the like will be substituted by the detailed description of the foregoing terminal 500, and the detailed description thereof will be omitted.

Computer-Readable Recording Medium

A remote maintenance method using the remote maintenance server according to an embodiment disclosed in the present disclosure as described above may be implemented in the form of program instructions that can be executed by various computer components, and may be stored on a computer-readable recording medium. The computer-readable recording medium may include program instructions, data files, data structures, and the like separately or in combination. The program instructions stored on the computer-readable recording medium may be specially designed and configured for the present invention, or may also be known and available to those skilled in the computer software field. Examples of the computer-readable recording medium include magnetic media such as hard disks, floppy disks, and magnetic tapes, optical media such as compact disk-read only memory (CD-ROM) and digital versatile disks (DVDs), magneto-optical media such as floptical disks, and hardware devices such as read-only memory (ROM), random access memory (RAM), and flash memory, which are specially configured to store and execute program instructions. Examples of the program instructions include not only machine language codes created by a compiler or the like, but also high-level language codes that can be executed by a computer using an interpreter or the like. The above hardware devices may be changed to one or more software modules to perform the operations of the present invention, and vice versa.

The foregoing preferred embodiments of the present disclosure are disclosed to solve technical tasks, and it will be apparent to those skilled in this art that various modifications, variations and additions can be made thereto without departing from the spirit and scope of the present invention. Those modifications and the like should be construed to be included in the following claims.

What is claimed is:

1. A remote maintenance server, comprising:
a communication unit configured to transmit and receive data to and from a facility that is in a control site;
a display unit configured to display a graphic object on a design drawing for the control site, wherein the graphic object corresponds to the facility of the control site; and
a controller configured to receive status information of the facility corresponding to the graphic object through the communication unit and to display the status information on the display unit.

2. The remote maintenance server of claim 1, further comprising:
a reader unit configured to read a program instruction including information on the design drawing and the facility,
wherein the controller extracts the information on the design drawing and the facility from the program instruction.

3. The remote maintenance server of claim 2, wherein the controller converts the information extracted from the program instruction and displays the information through a web browser.

4. The remote maintenance server of claim 1, further comprising:
an input unit configured to receive an user input to the graphic object.

5. The remote maintenance server of claim 4, wherein the controller transmits a control command through the communication unit to the facility corresponding to the graphic object according to one of the user input to the graphic object and a preset schedule.

6. The remote maintenance server of claim 1, wherein the communication unit receives status information from the facility, and
the display unit displays the graphic object according to the status information of the facility corresponding to the graphic object.

7. The remote maintenance server of claim 6, wherein when a facility corresponding to the graphic object is an abnormal state, the display unit displays a graphic object corresponding to the facility in an abnormal state has a different attribute than that of a graphic object corresponding to the same type of facility in a normal state.

8. The remote maintenance server of claim 2, wherein the program instruction includes information on a control zone having a plurality of control sites in which the facility is among the plurality of control sites, and
the controller reads information on the control zone using the reader unit, and
the display unit displays the control zone on the design drawing.

9. The remote maintenance server of claim 1, wherein the display unit displays a graphic object corresponding to a pipe connected between a plurality of the facilities.

10. The remote maintenance server of claim 1, wherein the display unit displays a schematic diagram showing a connection relation between a plurality of the facilities.

11. A remote maintenance system, comprising:
a remote maintenance server for remotely controlling a facility at a control site and:
a terminal connected to the remote maintenance server in a communicable manner,
wherein the remote maintenance server further comprises:
a reader unit configured to read a program instruction including information on a design drawing for the control site having the facility;
a controller configured to extract information on the design drawing and the facility from the program instruction; and
a communication unit configured to transmit the extracted information to the terminal to allow the terminal to display the design drawing and a graphic object corresponding to the facility.

12. A remote maintenance method using a remote maintenance server for remotely controlling a facility in a control site, the method comprising:
displaying a design drawing for a control site with a graphic object corresponding to the facility installed in the control site on a display of the remote maintenance server; and
receiving status information of the facility corresponding to the graphic object through a communication unit of the remote maintenance server; and
displaying the status information of the facility corresponding to the graphic object in the design drawing for the control site on the display of the remote maintenance server.

13. The method of claim 12, further comprising:
reading a program instruction in a reader unit of the remote maintenance server, the program instruction including information on the design drawing for the control site and the facility; and
extracting information on the design drawing and the facility from the program instruction in a controller of the remote maintenance server.

14. The method of claim 12, further comprising:
converting information extracted from the program instruction to be displayed through a web browser.

15. The method of claim 12, further comprising:
transmitting a control command through the communication unit to the facility corresponding to the graphic object according to one of a preset schedule and a user input to the graphic object.

16. The method of claim 12, further comprising:
determining an abnormal state in a facility; and
displaying a graphic object corresponding to the facility in an abnormal state with a different attribute than that of a graphic object corresponding to a same type of facility when the facility is in a normal state.

17. The method of claim 12, wherein the program instruction includes information on a control zone having a plurality of control sites in which the facility in a contro site among the plurality of control sites,
wherein said displaying the design drawing for the control site displays the control zone on the design drawing.

18. The method of claim 12, wherein said displaying the design drawing for the control site displays a graphic object corresponding to a pipe connected between the facilities.

19. The method of claim 12, wherein said displaying the design drawing for the control site displays a schematic diagram showing a connection relation between a plurality of the facilities.

20. A remote maintenance method using a remote maintenance server for remotely controlling a facility at a control site, the method comprising:
reading a program instruction in a reader unit of the remote maintenance server, the program instruction including information on a design drawing for the control site and the facility;
extracting information on the design drawing and the facility from the program instruction in a controller of the remote maintenance server;
transmitting the extracted information through a communication unit of the remote maintenance server to a terminal connected to the remote server; and
displaying the design drawing and a graphic object corresponding to the facility on the terminal.
